(19) United States
(12) Patent Application Publication
(10) Pub. No.: US 2014/0330498 A1
(43) Pub. Date: Nov. 6, 2014

(54) Vehicle Operation Support System and Navigation Apparatus

(71) Applicants: Hitachi Automotive Systems, Ltd., Hitachinaka-shi (JP); Clarion Co., Ltd., Tokyo (JP)

(72) Inventors: Norikazu NARA, Sagamihara-shi (JP); Mikio UEYAMA, Shimotsuga-gun (JP); Masao SAKATA, Tokyo (JP); Satoshi ITO, Tokyo (JP); Junya NAKAMURA, Tokyo (JP)

(21) Appl. No.: 14/315,556

(22) Filed: Jun. 26, 2014

Related U.S. Application Data
(63) Continuation of application No. 12/644,947, filed on Dec. 22, 2009.

(30) Foreign Application Priority Data
Dec. 22, 2008 (JP) 2008-325081

(51) Int. Cl. B60W 40/072

(52) U.S. Cl. CPC B60W 40/072
USPC 701/70

(57) ABSTRACT

A vehicle operation support system includes a navigation device, and a drive control device. The navigation device includes: part for storing road information including branch point information; and part for acquiring road curvature information with reference to the road information, and providing the drive control device with the road curvature information, before a vehicle reaches the branch point. The road curvature information includes information about curvature of first and second road sections extending forward from a branch point. The drive control device estimates entrance of the vehicle into one of the first and second road sections as a selected road section, and controls a driving state of the vehicle by operating an actuator with reference to information about curvature of the selected road section, in response to estimation of entrance of the vehicle into the selected road section.

### CROSS REFERENCE TO RELATED APPLICATIONS

This application is a continuation of U.S. patent application Ser. No. 12/644,947, filed Dec. 22, 2009, which claims benefit of Japanese patent application no. JP 2008-325081 filed Dec. 22, 2008 the entire disclosures of which are expressly incorporated by reference herein.

### BACKGROUND OF THE INVENTION

The present invention relates to vehicle operation support systems and navigation apparatuses for supporting vehicle operation with reference to road information.

Japanese Patent Application Publication No. 2001-289654 corresponding to U.S. Pat. No. 6,385,536 discloses a vehicle operation support system with a navigation device for a vehicle, which includes a section for locating the vehicle, a section for storing road information, a section for acquiring images of roads, a section for recognizing lane markers, a section for extracting characteristics of branch points, and a section for determination about branch points. For example, when the vehicle is traveling in an expressway and approaching a branch point where an exit road branches from a through traffic road, the vehicle operation support system: determines with reference to a result of recognition of lane markers which direction the vehicle is traveling in or which lane the vehicle is traveling in; corrects with a locator the location of the vehicle by map matching operation; then acquires information, such as road curvature, about the exit road, when determining that the vehicle is traveling to the exit road; and allows a drive control device to perform brake control or engine control with reference to the acquired information, so as to decelerate the vehicle.

### SUMMARY OF THE INVENTION

In the vehicle operation support system disclosed in Japanese Patent Application Publication No. 2001-289654, operation of acquiring information about a road section forward of the vehicle is synchronized with the map matching operation. In the case of the exit road of the expressway described above, after determination that the vehicle is traveling to the exit road, the operation of acquiring information about the exit road is suspended until a subsequent operation of map matching. This may cause a delay in start of operation of the drive control device.

On the other hand, in a typical navigation system, tasks of applications such as of a locator, and a HMI (Human-Machine Interface), tasks of intercommunications, etc., are executed with communication with each other. Accordingly, applications, such as of map matching, and lane selection estimation, which cooperate with an application of vehicle drive control, may be delayed by interruption of other tasks. In the case of the exit road of the expressway described above, when startup and operation of the locator is delayed by interruption of other applications such as of the HMI, a telephone, and intercommunications, the delay may cause a delay in the operation of acquiring information about the exit road which is performed after startup and operation of the locator. This problem may be significant, when the vehicle operation support system is configured with a CAN (Controller Area Network) network as a multiplex communication network.

In this way, in the vehicle operation support system disclosed in Japanese Patent Application Publication No. 2001-289654, when transmission of road information is delayed, the delay may cause a delay in start of operation of the drive control device, because the operation of the drive control device is performed with reference to the information acquired by map matching operation.

In view of the foregoing, it is desirable to provide a vehicle operation support system and a navigation apparatus which are capable of allowing a drive control device to operate with improved real-time response and reliability with no influence of delay in communication.

According to one aspect of the present invention, a vehicle operation support system for a vehicle, comprises: a map data storage part configured to store road information, wherein the road information includes branch point information; a drive control device configured to control with an actuator a driving state of the vehicle; and a road information acquiring part configured to: acquire forward road information with reference to the road information, wherein the forward road information includes at least: information about a first road section extending forward from a branch point; and information about a second road section extending forward from the branch point; and provide the drive control device with the forward road information, before the vehicle reaches the branch point. The vehicle operation support system may be further configured so that: the vehicle operation support system further comprises a road selection estimation part configured to estimate entrance of the vehicle into one of the first and second road sections as a selected road section; the map data storage part and the road information acquiring part constitute a navigation device; the information about the first road section includes at least information about curvature of the first road section; the information about the second road section includes at least information about curvature of the second road section; and the drive control device is further configured to control the driving state of the vehicle by operating the actuator with reference to the information about curvature of the selected road section, in response to estimation of entrance of the vehicle into the selected road section. The vehicle operation support system may be further configured so that: the actuator includes an automatic brake control device configured to automatically apply a braking force to the vehicle; and the braking force is set with reference to the information about curvature of the selected road section for deceleration of the vehicle. The vehicle operation support system may be further configured so that: the branch point is a branch point in an expressway; the first road section is a section of a through traffic road of the expressway; and the second road section is an exit road section branching from the through traffic road at the branch point. The vehicle operation support system may be further configured so that the forward road information is acquired with reference to at least one of: a first distance that is traveled by the vehicle during a time interval between two consecutive operations of map matching performed by the navigation device; a second distance that is traveled by the vehicle during a time period required for startup of the navigation device; and a third distance that is required for deceleration of the vehicle at a predetermined deceleration from current travel speed to desired travel speed in the exit road section. The vehicle operation support system may be further configured so that: a branch point control target section is defined as extending backward from the branch point by a sum of: a first distance that is traveled by the vehicle during a time interval between two consecutive operations of map matching performed by the navigation device; a second distance that is traveled by the vehicle during a time period required for startup of the navigation device; and a third distance that is required for deceleration of the vehicle at a predetermined deceleration from current travel speed to desired travel speed in the exit road section; and the road information acquiring part is configured to acquire the forward road information, in response to recognition that the vehicle reaches a preview starting point as a starting point of the branch point control target section. The vehicle operation support system may be further configured so that: a preview information communication completion point is defined as a point backward from the branch point by a sum of the second distance and the third distance; and the road information acquiring part is configured to provide the drive control device with the forward road information, before the vehicle reaches the preview information communication completion point. The vehicle operation support system may be further configured so that the road information acquiring part is configured to: acquire and provide the drive control device with information about a forward section of the through traffic road forward of the vehicle at intervals of a predetermined constant time period, in response to recognition that the vehicle is traveling outside the branch point control target section; and provide the drive control device with the information about the forward section of the through traffic road and the information about the exit road section, in response to recognition that the vehicle is traveling within the branch point control target section, before the vehicle reaches the preview information communication completion point. The vehicle operation support system may be further configured so that: the braking force of the automatic brake control device is set with reference to desired passing speed depending on the information about curvature of the selected road section; and the drive control device is configured to output a warning signal, in response to determination that it is impossible to decelerate the vehicle to the desired passing speed. The vehicle operation support system may be further configured so that the road selection estimation part is configured to estimate entrance of the vehicle into the selected road section with reference to an image acquired by a camera that is mounted to the vehicle. The vehicle operation support system may be further configured so that the navigation device is configured to: acquire the forward road information in predetermined timing; and provide the drive control device with the forward road information in one of first and second manners, wherein the first manner is a manner in which the drive control device is provided with the forward road information on a single occasion, and wherein the second manner is a manner in which the drive control device is provided with the forward road information intermittently on a plurality of occasions.

According to another aspect of the present invention, a vehicle operation support system for a vehicle, comprises: a navigation device; and a drive control device configured to control with an actuator a driving state of the vehicle, wherein: the navigation device includes: a map data storage part configured to store road information, wherein the road information includes branch point information; and a road information acquiring part configured to: acquire road curvature information with reference to the road information, wherein the road curvature information includes at least: information about curvature of a first road section extending forward from a branch point; and information about curvature of a second road section extending forward from the branch point; and provide the drive control device with the road curvature information, before the vehicle reaches the branch point; the drive control device includes a road selection estimation part configured to estimate entrance of the vehicle into one of the first and second road sections as a selected road section; and the drive control device is further configured to control the driving state of the vehicle by operating the actuator with reference to the information about curvature of the selected road section, in response to estimation of entrance of the vehicle into the selected road section.

According to a further aspect of the present invention, a navigation apparatus for a vehicle, comprising a road information acquiring part configured to: acquire forward road information with reference to stored map data, wherein the forward road information is information about a plurality of roads in a road network forward of the vehicle; and send the forward road information to an external control device. The forward road information may include at least: information about a branch point in the road network; information about curvature of a first road section extending forward from the branch point; and information about curvature of a second road section extending forward from the branch point.

### BRIEF DESCRIPTION OF THE DRAWINGS

FIG. 1 is a schematic diagram showing a vehicle operation support system according to a first embodiment of the present invention.

FIG. 2 is a schematic diagram showing an example of a section of an expressway which includes a branch point.

FIG. 3 is a functional block diagram showing functional blocks of a navigation system of the vehicle operation support system shown in FIG. 1.

FIG. 4 is a diagram illustrating a method of route prediction.

FIG. 5 is a functional block diagram showing functional blocks of a drive control device of the vehicle operation support system shown in FIG. 1.

FIG. 6 is a schematic diagram showing an extended section of the expressway which includes the section shown in FIG. 2, where some points and sections are specifically defined.

FIG. 7 is a schematic diagram showing a vehicle operation support system according to a modification of the first embodiment.

FIG. 8 is a flow chart showing a procedure of branch point control to be performed by the vehicle operation support system shown in FIG. 1.

FIG. 9 is a flow chart showing a sub-procedure constituting the procedure shown in FIG. 8.

FIG. 10 is a flow chart showing a sub-procedure constituting the procedure shown in FIG. 8.

FIG. 11 is a schematic diagram showing the section of the expressway shown in FIG. 2, where forward road information is illustrated.

FIG. 12 is a diagram illustrating a method of acquiring road curvature information (in the form of radius of curvature).

FIG. 13 is a diagram illustrating another method of acquiring road curvature information (in the form of radius of curvature).

FIG. 14 is a diagram showing points about which road curvature information is acquired.

FIG. 15 is a table showing an example of a format of the road curvature information of FIG. 14.

FIG. 16 is a schematic diagram illustrating a method of road selection estimation (or lane selection estimation) in the section of the expressway shown in FIG. 2

FIG. 17 is a flow chart showing a procedure according to the method of road selection estimation shown in FIG. 16.

FIG. 18 is a schematic diagram illustrating another method of road selection estimation in the section of the expressway shown in FIG. 2.

FIG. 19 is a flow chart showing a procedure according to the method of road selection estimation shown in FIG. 18.

FIG. 20 is a flow chart showing a procedure of image recognition to be performed by an image recognition device of the vehicle operation support system shown in FIG. 1.

FIG. 21 is a diagram illustrating a method of calculation of desired passing speed at target nodes.

FIG. 22A is a time chart showing operation of vehicle operation support system according to a reference example, and FIG. 22B is a time chart showing operation of the vehicle operation support system shown in FIG. 1.

FIG. 23 is a diagram illustrating a method of identifying links during route prediction.

FIG. 24 is a diagram illustrating a method of identifying nodes during route prediction.

FIG. 25 is a diagram illustrating a method of treating a circular path during identification of links and nodes.

FIG. 26 is a schematic diagram showing a section of an expressway where forward road information is illustrated for the case of a vehicle operation support system according to a second embodiment of the present invention.

FIG. 27 is a schematic diagram showing a section of an expressway which includes a different type of branch point than the section shown in FIG. 26.

FIG. 28 is a flow chart showing a procedure of branch point control to be performed by the vehicle operation support system according to the second embodiment.

FIG. 29 is a flow chart showing a sub-procedure constituting the procedure shown in FIG. 28.

FIG. 30 is a flow chart showing a sub-procedure constituting the procedure shown in FIG. 28.

FIG. 31 is a diagram illustrating a method of acquiring road curvature information.

FIG. 32 is a table showing an example of a format of the road curvature information of FIG. 31.

FIG. 33 is a schematic diagram illustrating a method of road selection estimation in the section of the expressway shown in FIG. 26.

FIG. 34 is a flow chart showing a procedure according to the method of road selection estimation shown in FIG. 33.

FIG. 35 is a schematic diagram illustrating another method of road selection estimation in the section of the expressway shown in FIG. 26.

FIG. 36 is a flow chart showing a procedure according to the method of road selection estimation shown in FIG. 35.

FIG. 37 is a flow chart showing a procedure of branch point control to be performed by a vehicle operation support system according to a third embodiment of the present invention.

FIG. 38 is a flow chart showing a sub-procedure constituting the procedure shown in FIG. 37.

FIG. 39 is a flow chart showing a sub-procedure constituting the procedure shown in FIG. 37.

FIG. 40 is a flow chart showing a procedure of branch point control to be performed by a vehicle operation support system according to a fourth embodiment of the present invention.

FIG. 41 is a flow chart showing a sub-procedure constituting the procedure shown in FIG. 40.

FIG. 42 is a flow chart showing a sub-procedure constituting the procedure shown in FIG. 40.

### DETAILED DESCRIPTION OF THE INVENTION

### First Embodiment

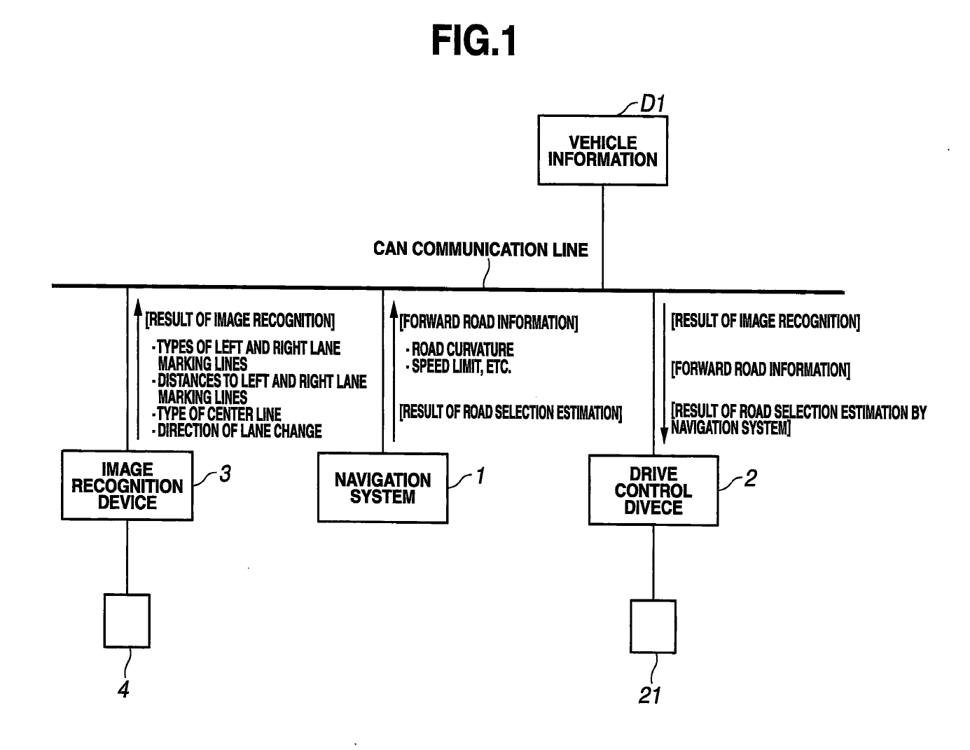

The following describes a vehicle operation support system according to a first embodiment of the present invention with reference to FIGS. 1 to 25. FIG. 1 schematically shows configuration of the vehicle operation support system.

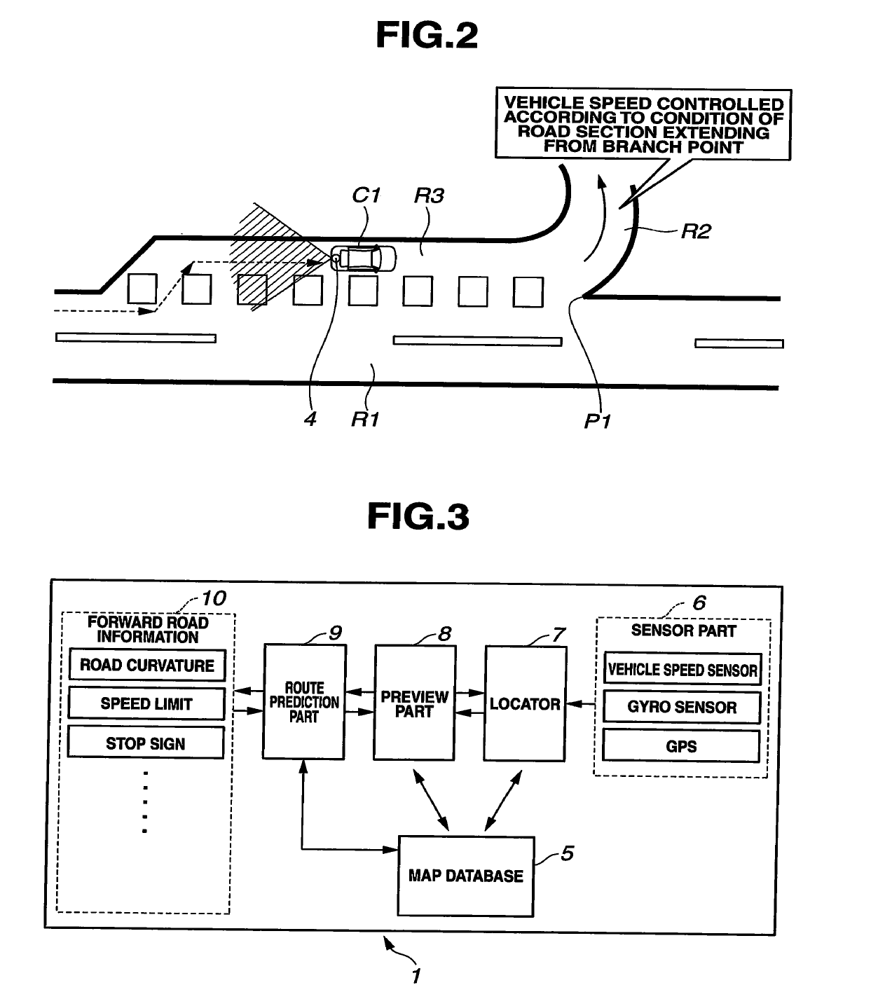

The vehicle operation support system is adapted, for example, to a section of an expressway as shown in FIG. 2 in which an exit road as a branch road R2 branches from a through traffic road (or main road) R1 through a deceleration lane R3. As described in detail below, the vehicle operation support system is configured to: suitably determine which of the through traffic road R1 and branch road R2 a host vehicle C1 is going to travel in, before host vehicle C1 reaches a branch point P1; and perform engine control and/or brake control with a drive control device, with reference to information, such as curvature data, speed limit data, etc., about the branch road R2, so that the host vehicle C1 can continue smoothly traveling while suitably decelerating.

The vehicle operation support system may be also applied to a branch point in an expressway, where a branch road such as an entrance road to a parking area or service area, or a connection road at a junction to another expressway, branches from a through traffic road, similar to the exit road shown in FIG. 2. In such a case, the branch road has a relatively tightly curved shape, or is provided with a junction or a toll gate, so that the host vehicle C1 is requested to decelerate in the branch road R2 in general.

As shown in FIG. 1, the vehicle operation support system includes a navigation system (navigation device) 1, a drive control device 2, and an image recognition device 3. Drive control device 2 is configured to perform engine control and/or brake control for vehicle speed control. Image recognition device 3 is configured to recognize types and positions of white lane marking lines painted on a road surface, and then identify a road or lane where the host vehicle C1 is traveling, and lane change (road change or road selection) of the host vehicle C1. Image recognition device 3 is provided with an on-board rear camera 4 that is mounted to a rear part of host vehicle C1, and directed toward the road surface for acquiring images of the road surface on which white lane marking lines are painted. Navigation system 1, drive control device 2, image recognition device 3, and on-board camera 4 are connected through a CAN network as an on-board LAN network. Vehicle information D1 is read through the CAN network as occasions arise. Each of navigation system 1, drive control device 2, and image recognition device 3 is constituted by an electrical control unit (ECU) as a main part. Image recognition device 3 serves as a road selection estimation section, as described in detail below.

As shown in FIG. 3, navigation system 1 includes a map database (map data storage part) 5, a sensor part 6, a locator 7, a preview part 8, a route prediction part 9, and a forward road information acquiring part (or road information acquiring part) 10. Sensor part 6 includes a vehicle speed sensor, a gyro sensor, and a GPS (Global Positioning System).

Map database 5 stores map data, and road data (road information) as information about a road network. The road data includes branch point data (branch point information). More specifically, the road data includes road type data, node type data, node attribute data, link type data, link attribute data, branch point location data, intersection location data, radius of curvature data, and speed limit data. The road types include intercity expressway, city expressway, toll road, national road, prefectural road, major local road, general road, narrow road, etc. The link types include through traffic link (where opposite lanes are not separated), through traffic link (where opposite lanes are separated), connection road link (between through traffic roads), connection road link (ramp), service road link such as leading to a service area (SA), etc.

Locator 7 is configured to: calculate the current position of host vehicle C1 with reference to the signals from sensor part 6, at intervals of a predetermined time period which is about one second for example; and then project the calculated position of host vehicle C1 on the map data, so as to locate the host vehicle C1 on the map. The former operation is called dead reckoning, and the latter operation is called map matching. The predetermined time period may be changed depending on the travel speed of host vehicle C1.

Preview part 8 is configured to access the locator 7 and map database 5 at intervals of a predetermined time period or a predetermined constant time period, and acquire or collect map data and road data about a predetermined region around the host vehicle C1 and a predetermined region forward of host vehicle C1, from map database 5, with reference to the location of host vehicle C1 provided by locator 7. This road data is referred to as forward road information. Route prediction part 9 is configured to find candidate routes within a predetermined area of prediction, and predict which of the candidate routes the host vehicle C1 is going to select or travel in, with reference to the collected map data and road data. The acquired forward road information is outputted through the CAN network to drive control device 2, as described in detail below. In the case of vehicle speed control in the branch road R2 shown in FIG. 2, road type data, link type data, road curvature data, and speed limit data are major part of the forward road information.

When a destination is set with navigation system 1, so that a navigation route is found and set between the location of host vehicle C1 and the destination on the map, then route prediction part 9 sets a predicted route in conformance with the navigation route. When no destination is set with navigation system 1, then route prediction part 9 compares the road type (national road or prefectural road, for example) or link type of a first road section leading to a branch point with the road type or link type of second and third road sections extending forward from the branch point, and selects one of the second and third road sections whose road type or link type is the same as the first road section. If both of the second and third road sections have the same road type or link type as the first road section, then route prediction part 9 selects one of the second and third road sections whose link angle θ is smaller than the other.

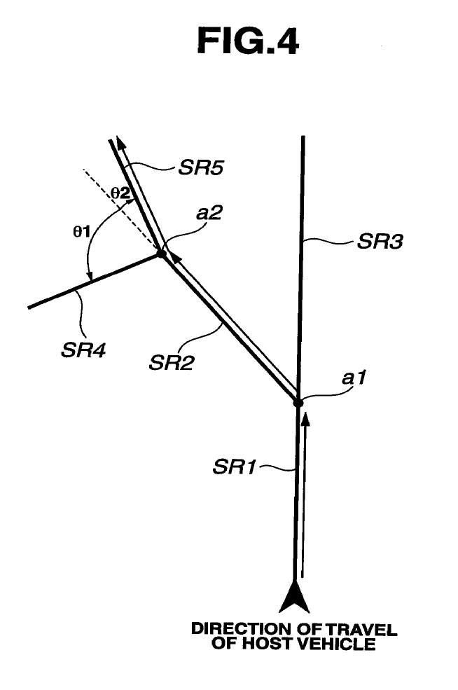

FIG. 4 shows an example in which a national road SR1 branches at a branch point a1 into a prefectural road SR3 and a national road SR2 which branches at a branch point a2 into a prefectural road SR4 and a prefectural road SR5. In this example, the route prediction part 9 selects at branch point a1 the national road SR2 whose road type is the same as national road SR1, and selects at branch point a2 the prefectural road SR5 whose link angle θ2 is smaller than link angle θ1 of prefectural road SR4.

The route prediction operation of route prediction part 9 is synchronized with and performed after the operation of preview part 8. Accordingly, the route prediction operation of route prediction part 9 is performed at intervals of a predetermined time period or a predetermined constant time period, similar to the operation of preview part 8.

Forward road information acquiring part 10 is configured to communicate with the other parts of navigation system 1, and arrange information to be sent to drive control device 2. As described in detail below, forward road information acquiring part 10 acquires forward road information with reference to the road information, wherein the forward road information includes at least: information about a first road section extending forward from a branch point; and information about a second road section extending forward from the branch point; and provides the drive control device 2 with the forward road information, before host vehicle C1 reaches the branch point.

Drive control device 2 is configured to control a driving state, such as vehicle speed, of host vehicle C1. Specifically, drive control device 2 directly controls an actuator 21 of a drive control system of host vehicle C1, such as an engine throttle actuator, and/or an actuator for braking operation (referred to as brake actuator), as described in detail below. Drive control device 2 acquires information needed for the drive control, through the CAN network from navigation system 1 and image recognition device 3. Drive control device 2 may be configured to control other actuators such as an actuator for shift control for a transmission. The brake actuator may be an actuator for an automatic braking system. Namely, the brake actuator may be an automatic brake control device configured to automatically apply a braking force to the vehicle. In such a case, the braking force is set with reference to information about curvature of a target road section extending forward from a branch point, for deceleration of the vehicle, as described in detail below.

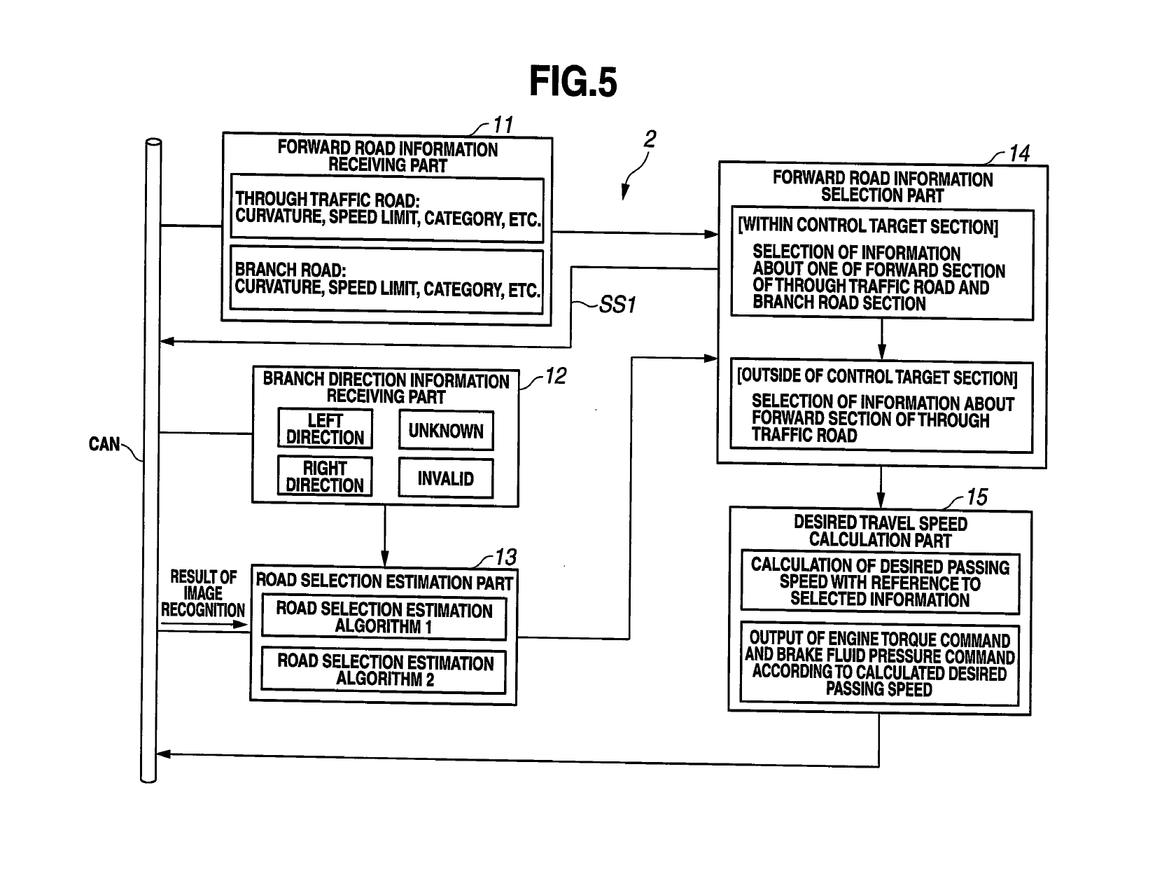

As shown in FIG. 5, drive control device 2 includes a forward road information receiving part 11, a branch direction information receiving part 12, a road selection estimation part (road selection detection part) 13, a forward road information selection part 14, and a desired travel speed calculation part 15. Forward road information receiving part 11 receives information from navigation system 1. Branch direction information receiving part 12 receives information about the direction in which the branch road R2 branches from the through traffic road R1. Road selection estimation part 13 receives information from image recognition device 3 and branch direction information receiving part 12, and estimates or identifies the road or lane where the host vehicle C1 is traveling. Forward road information selection part 14 receives information from forward road information receiving part 11 and road selection estimation part 13, and selects information about one of branch road section R2 and a section of the through traffic road R1 forward of host vehicle C1. Desired travel speed calculation part 15 receives information from the forward road information selection part 14, and calculates desired travel speed.

Image recognition device 3 reads image data acquired by on-board camera 4, and treats the image data with an image recognition processing. Image recognition device 3 recognizes the line types of lane marking lines on the left and right sides of host vehicle C1, distances to the left and right lane marking lines, and the type of a center line, and estimates whether or not the host vehicle C1 straddles a lane marking line, and whether or not the host vehicle C1 is going to perform road change or lane change. Image recognition device 3 outputs that information to drive control device 2 through the CAN network. The function of estimation whether or not the host vehicle C1 is going to perform road change or lane change may be implemented by a device which is provided separately from image recognition device 3, or may be implemented in drive control device 2.

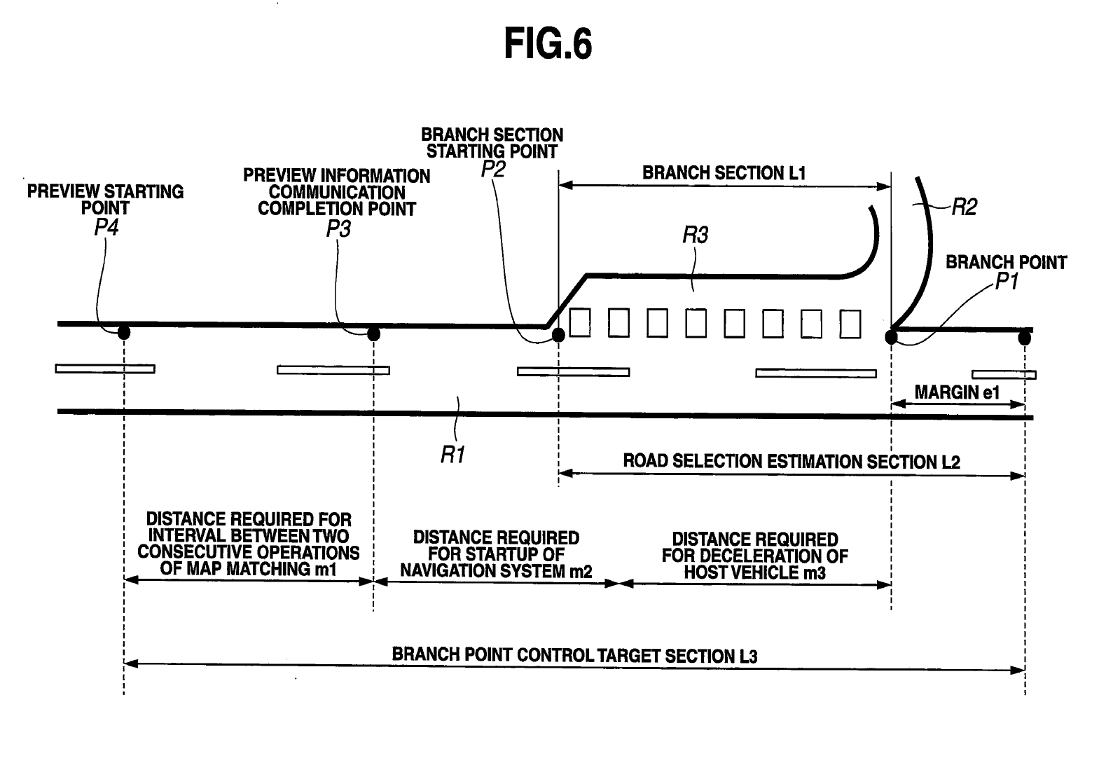

FIG. 6 schematically shows an extended section of the expressway shown in FIG. 2, where some points and sections are specifically defined. A branch point P1 is a point at which the branch road R2 branches from the through traffic road R1. Specifically, the branch point P1 is a node between two adjacent links of the through traffic road R1 and the branch road R2, or a shape interpolation point. A branch section starting point P2 is a point from which the deceleration lane R3 extends forward. A branch section L1 is a section between the branch point P1 and the branch section starting point P2. A road selection estimation section L2 is a section between the branch section starting point P2 and a reference point which is forward of the branch point P1 by a predetermined margin of distance e1. A preview information communication completion point P3 is a point that is located a predetermined distance behind the branch section starting point P2. A preview starting point P4 is a point that is located a predetermined distance behind the preview information communication completion point P3. A branch point control target section L3 is a section between the reference point and the preview starting point P4. The lengths of branch section L1 and road selection estimation section L2 are predetermined at certain values.

The preview starting point P4 is set so that the branch point control target section L3 extends over the sum of distances m1, m2 and m3 backward from the branch point P1. The distance m1 is a distance which corresponds to an interval between two consecutive operations of map matching of navigation system 1. The distance m2 is a distance which corresponds to a time period required for startup of navigation system 1. The distance m3 is a distance which is needed to decelerate the host vehicle C1 from current travel speed to desired passing speed in the branch road R2. In this way, the length of the branch point control target section L3 is also predetermined at a certain value (=e1+m1+m2+m3).

The preview information communication completion point P3 is set so that the section between the branch point P1 and preview information communication completion point P3 extends over the sum of distance m2 and distance m3.

Navigation system 1 is configured to automatically restart, when navigation system 1 hangs accidentally. The time period required for startup of navigation system 1 is provided and set for cases of such restart.

The vehicle operation support system is configured to determine whether or not the host vehicle C1 is going to enter the branch road R2, when the host vehicle C1 is traveling within the road selection estimation section L2, as described in detail below. The vehicle operation support system is characterized at least in that before the host vehicle C1 reaches the preview information communication completion point P3 which is located behind the road selection estimation section L2, i.e. before it is determined whether or not the host vehicle C1 enters the branch road R2 at branch point P1, the vehicle operation support system previews information (road type data, road curvature data, speed limit data, etc.) about the section of through traffic road R1 extending forward from branch point P1, and information about branch road section R2, and sends both to drive control device 2. The information may include various kinds of data such as gradient data (ascending or descending, or gradient value) which may be used to provide improved vehicle drive control.

The forward road information receiving part 11 of drive control device 2 receives information (road type data, road curvature data, speed limit data, etc.) about the section of through traffic road R1 extending forward from branch point P1, and about branch road section R2 extending forward from branch point P1, which is previewed by navigation system 1, before it is determined whether or not the host vehicle C1 enters the branch road R2 at branch point P1. The information about the section of through traffic road R1 extending forward from branch point P1 is referred to as “through traffic road forward road information”, and the information about the branch road section R2 is referred to as “branch road forward road information”.

The information that the branch road R2 branches to the left side from through traffic road R1 at branch point P1 as shown in FIG. 6, is obtained with reference to the link type of branch road R2. Accordingly, the branch direction information receiving part 12 of drive control device 2 shown in FIG. 5 receives this information from navigation system 1.

The road selection estimation part 13 of drive control device 2 shown in FIG. 5 is configured to estimate or detect entrance of host vehicle C1 into one of road sections extending forward from a branch point, as a selected road section. Road selection estimation part 13 receives a result of image recognition from image recognition device 3 which is obtained when the host vehicle C1 is traveling in the road selection estimation section L2 shown in FIG. 6. With reference to the result, the road selection estimation part 13 determines with a predetermined road selection estimation algorism whether or not the host vehicle C1 performs road change based on lane change before reaching the branch point P1. The road selection estimation algorism is described in detail below.

The forward road information selection part 14 of drive control device 2 shown in FIG. 5 selects one of the through traffic road forward road information and branch road forward road information which are outputted from the forward road information receiving part 11, with reference to a result of road selection estimation outputted from road selection estimation part 13, which includes information about the current location of the host vehicle C1. Specifically, when the host vehicle C1 is traveling within the branch point control target section L3 shown in FIG. 6, the forward road information selection part 14 selects one of the through traffic road forward road information and branch road forward road information, with reference to the result of road selection estimation from road selection estimation part 13. When the host vehicle C1 is traveling outside of the branch point control target section L3 shown in FIG. 6, the forward road information selection part 14 selects the through traffic road forward road information. The information about which one of the through traffic road forward road information and branch road forward road information is selected by forward road information selection part 14, is sent in the form of a feedback information SS1 to navigation system 1, for synchronization between drive control device 2 and navigation system 1.

The desired travel speed calculation part 15 of drive control device 2 shown in FIG. 5 calculates desired travel speed (or desired passing speed) with reference to the selected information from the forward road information selection part 14. With reference to the desired travel speed, the desired travel speed calculation part 15 calculates desired engine torque and/or desired brake fluid pressure, and outputs that information in the from of command signals to the engine throttle actuator and/or brake actuator.

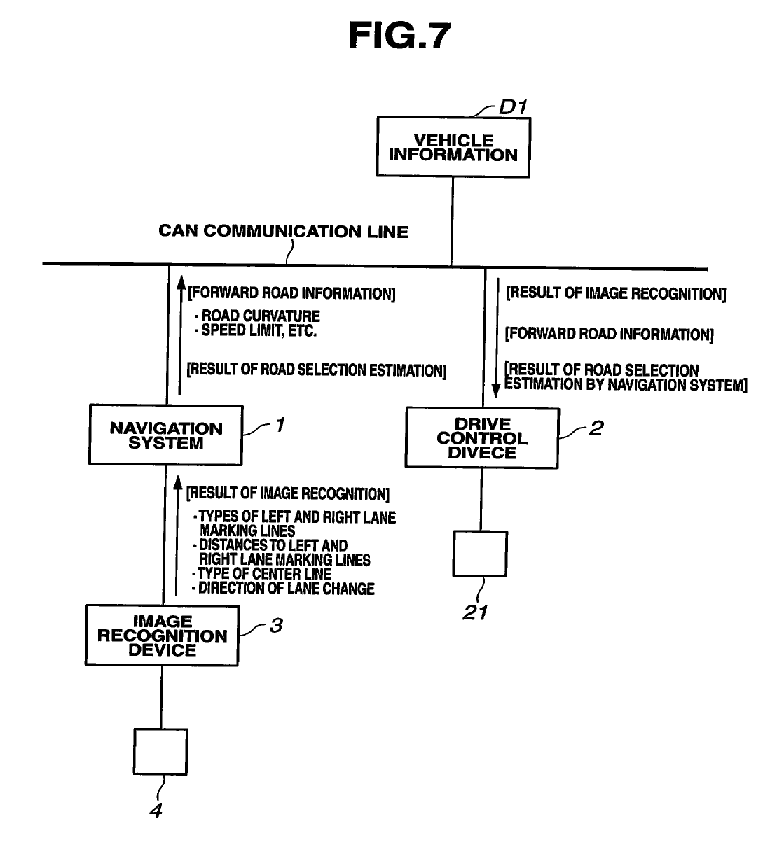

The configuration of the vehicle operation support system shown in FIG. 1 where image recognition device 3 is provided independently, may be modified into a configuration as shown in FIG. 7 where image recognition device 3 is connected directly to navigation system 1. However, the configuration shown in FIG. 1 is advantageous in view of real-time communication between drive control device 2 and image recognition device 3.

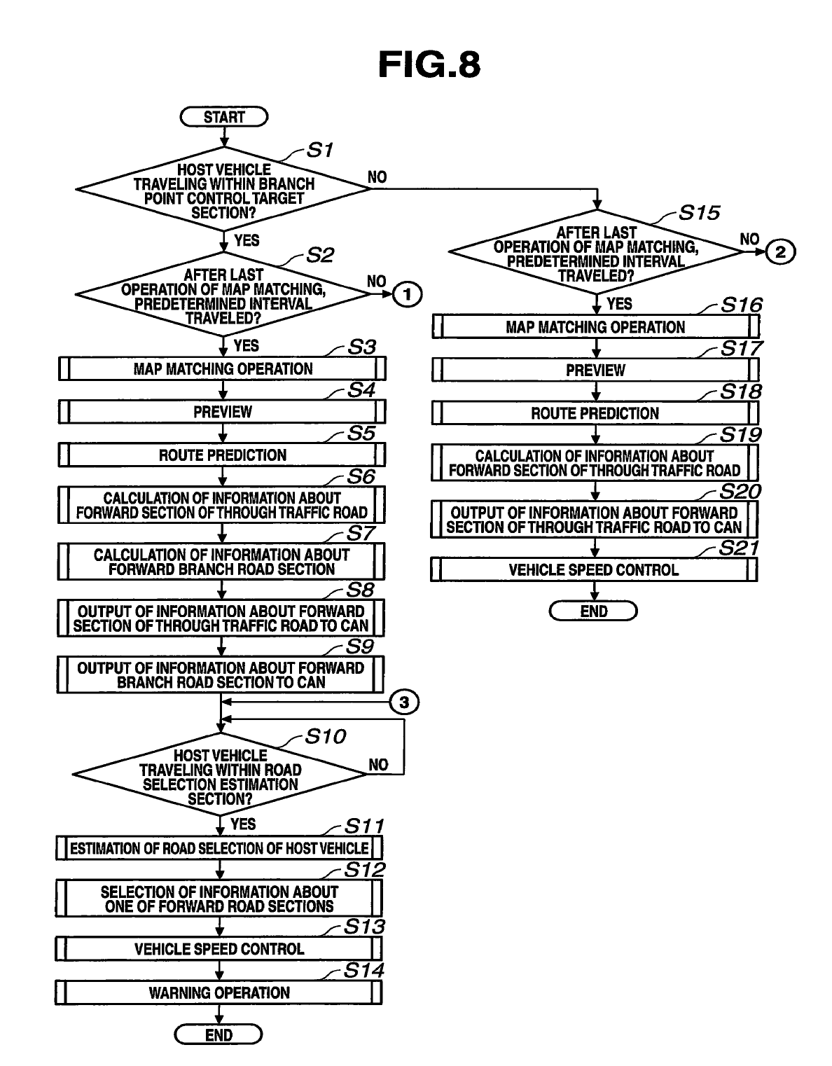

FIGS. 8 to 10 show a procedure of branch point control to be performed by the vehicle operation support system described above.

At Step S1, navigation system 1 determines with reference to information about the current location of host vehicle C1 whether or not host vehicle C1 is traveling within the branch point control target section L3 shown in FIG. 6. When determining that the host vehicle C1 is traveling within the branch point control target section L3, then the procedure proceeds to Step S2 at which the navigation system 1 determines whether or not the host vehicle C1 has traveled a predetermined interval after the last operation of map matching. When the navigation system 1 determines that the host vehicle C1 has traveled the interval, then the procedure proceeds to Step S3 at which navigation system 1 performs map matching operation which is a basic function of navigation system 1. Subsequently, at Step S4, navigation system 1 previews and collects map data about the region around host vehicle C1 and the region forward of host vehicle C1. Subsequently, at Step S5, navigation system 1 finds candidate routes within the predetermined area of prediction, and predicts which of the candidate routes the host vehicle C1 is going to select or travel in, with reference to the collected map data.

When host vehicle C1 is traveling within the branch point control target section L3 shown in FIG. 6, i.e. when the host vehicle C1 has reached the preview starting point P4 shown in FIG. 6, then navigation system 1 acquires by collection or calculation at the predetermined intervals or predetermined constant intervals the through traffic road forward road information in the form of information (road type data, road curvature data, speed limit data, etc.) about a section of through traffic road R1 included in the predicted route, which section extends forward by a predetermined distance from host vehicle C1, at Step S6. Naturally, the information about the section of through traffic road R1 extending forward from host vehicle C1 includes the through traffic road forward road information which is information about the section of through traffic road R1 extending forward from branch point P1, and is referred to as “overall through traffic road forward road information” if strictly described. Before host vehicle C1 reaches the preview information communication completion point P3 shown in FIG. 6, navigation system 1 sends or outputs the acquired overall through traffic road forward road information to drive control device 2 through the CAN network, at Step S8.

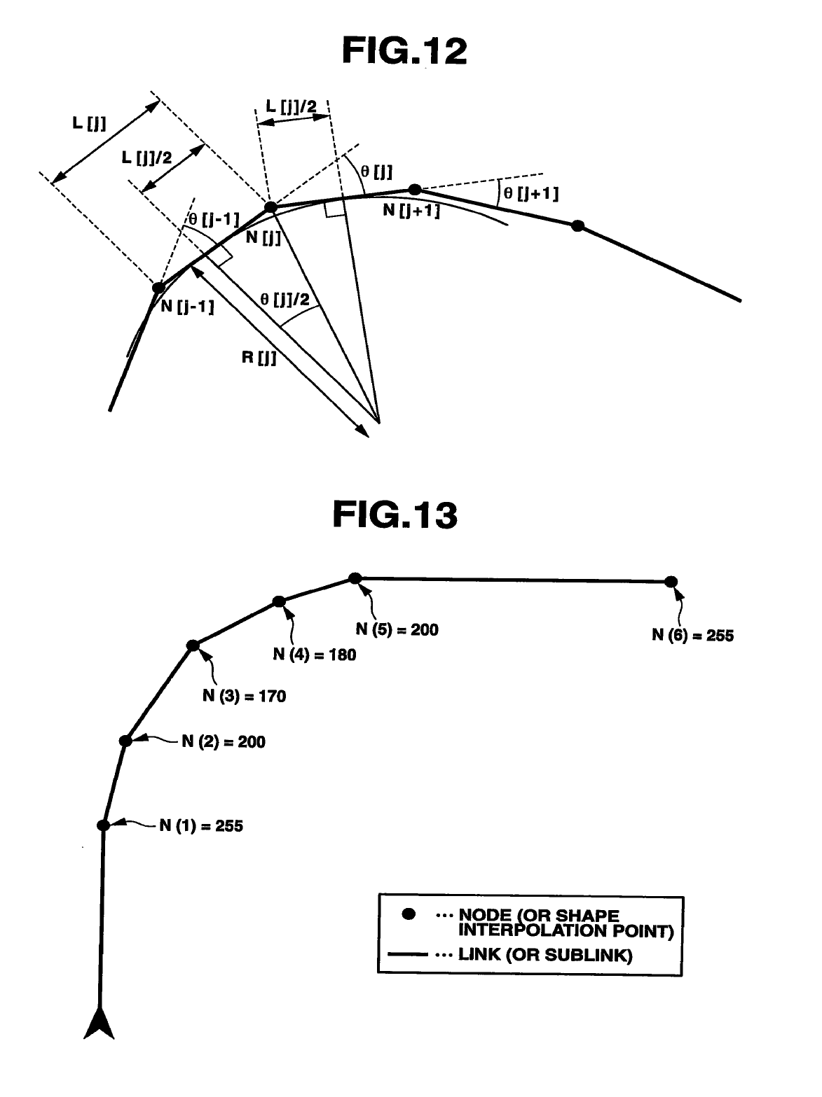

Part of forward road information (road type data, road curvature data, speed limit data, etc.) is obtained by reading data recorded in the map data, whereas the other part is obtained by predetermined calculation. For example, road curvature data in the form of radius of curvature may be calculated sequentially with reference to link angle data, or may be obtained by reading data which is stored in the map data as well as the link data and node data. In the case of calculation, the radius of curvature R[j] of a road at a node or shape interpolation point N[j] is calculated as a radius of a circle which is tangent to two adjacent links close to the point N[j], using equation (0), as shown in FIG. 12.

R[j]={L[j]/2}/tan(θ[j]/2) (0)

where L[j] represents the length of a j-th link (or shape interpolation link).

Calculation of radius of curvature may be implemented differently. On the other hand, in the case of reading, information about radius of curvature at nodes and shape interpolation points is recorded beforehand, and sequentially read by the preview part 8 of navigation system 1 to obtain the radius of curvature at each node forward of host vehicle C1.

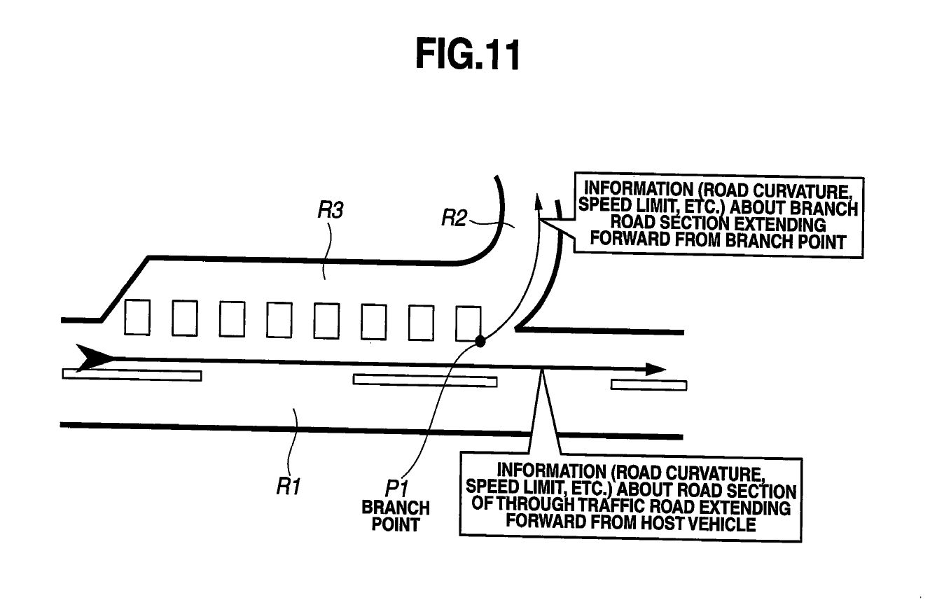

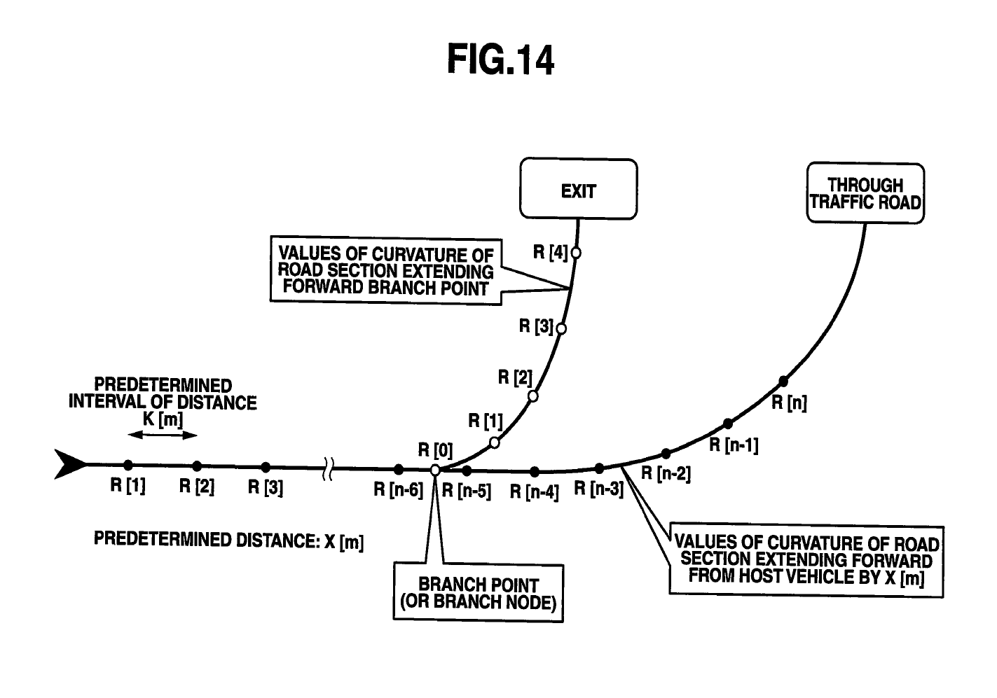

The situation shown in FIG. 11 is modeled into FIG. 14, which shows points about which forward road information is acquired. For example, navigation system 1 acquires road curvature data in the form of radius of horizontal curvature R[n] as an element of the overall through traffic road forward road information, as follows. As shown in FIG. 14, navigation system 1 acquires at the predetermined intervals or predetermined constant intervals the radius of curvature of through traffic road R1 at n points, R[i] (i=0, 1, 2, . . . , n, i=0 indicating the current location of host vehicle C1), where the points are arranged in the through traffic road R1 at intervals of a predetermined distance k (m) between the current location of host vehicle C1 and a point forward of the current location by a predetermined forward distance x (m). Then, navigation system 1 sends the acquired data to drive control device 2.

Branch road R2 is treated similarly. Specifically, navigation system 1 obtains by collection or calculation at the predetermined intervals or predetermined constant intervals the branch road forward road information which is information about a section of branch road R2 extending forward by a predetermined distance from branch point P1 which is within the predetermined area of prediction, at Step S7. Before host vehicle C1 reaches the preview information communication completion point P3 shown in FIG. 6, navigation system 1 sends or outputs the acquired branch road forward road information to drive control device 2 through the CAN network, at Step S9.

For example, navigation system 1 acquires road curvature data in the form of radius of curvature R[n] as an element of the branch road forward road information, as follows. As shown in FIG. 14, navigation system 1 acquires at the predetermined intervals or predetermined constant intervals the radius of curvature at n points, R[i] (i=0, 1, 2, . . . , n, i=0 indicating the branch point P1), where the points are arranged in the branch road R2 at intervals of a predetermined distance k (m) between the branch point P1 and a point forward of branch point P1 by a predetermined forward distance x (m). Then, navigation system 1 sends the acquired data to drive control device 2.

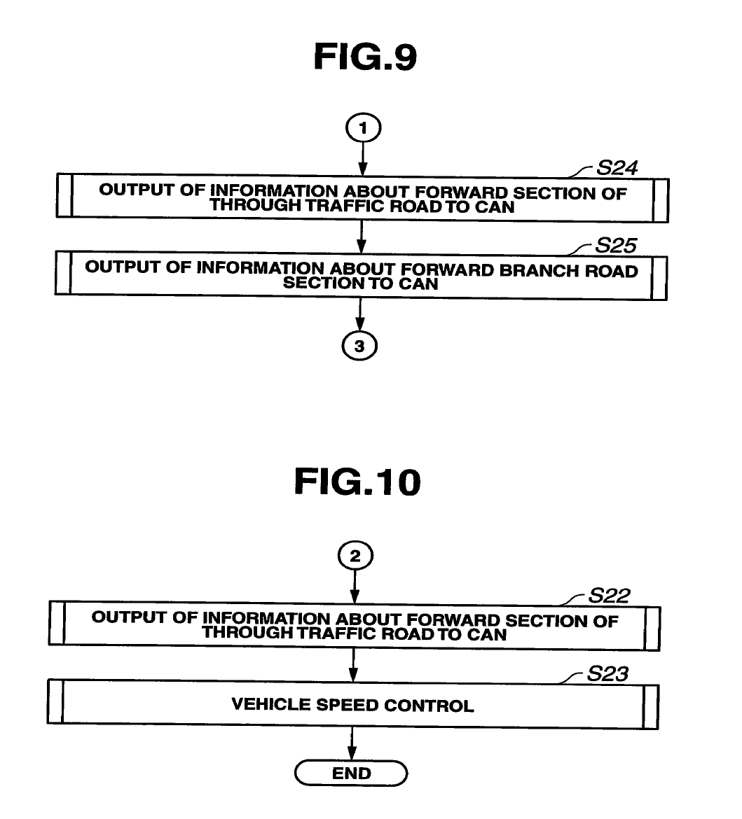

When determining at Step S2 that the host vehicle C1 has not yet traveled the predetermined interval after the last operation of map matching, then the procedure proceeds to Steps S24 and S25 in FIG. 9 at which the navigation system 1 sends or outputs the previously-acquired overall through traffic road forward road information and branch road forward road information to drive control device 2 through the CAN network.

When determining at Step S1 that the host vehicle C1 is traveling outside of the branch point control target section L3 shown in FIG. 6, then the procedure proceeds to Step S15 at which the navigation system 1 determines whether or not the host vehicle C1 has traveled the predetermined interval after the last operation of map matching. When the navigation system 1 determines that the host vehicle C1 has traveled the predetermined interval after the last operation of map matching, then the procedure proceeds to Steps S16, S17 and S18 at which navigation system 1 performs the same operations as at Steps S3, S4 and S5. Then, navigation system 1 acquires by collection or calculation at the predetermined intervals or predetermined constant intervals the overall through traffic road forward road information, at Step S19. Navigation system 1 sends or outputs the acquired overall through traffic road forward road information to drive control device 2 through the CAN network, at Step S20.

For example, navigation system 1 acquires road curvature data in the form of radius of curvature R[n] as an element of the overall through traffic road forward road information, as follows. As shown in FIG. 14, navigation system 1 acquires at the predetermined intervals or predetermined constant intervals the radius of curvature of through traffic road R1 at n points, R[i] (i=0, 1, 2, . . . , n, i=0 indicating the current location of host vehicle C1), where the points are arranged in the through traffic road R1 at intervals of a predetermined distance k (m) between the current location of host vehicle C1 and a point forward of the current location by a predetermined forward distance x (m). Then, navigation system 1 sends the acquired data to drive control device 2.

When determining at Step S15 that the host vehicle C1 has not yet traveled the predetermined interval after the last operation of map matching, then the procedure proceeds to Step S22 in FIG. 10 at which the navigation system 1 sends or outputs the previously-acquired overall through traffic road forward road information to drive control device 2 through the CAN network.

At Step S21 subsequent to Step S20, and at Step S23 subsequent to Step S22, the drive control device 2 shown in FIG. 5 performs vehicle speed control with reference to the received overall through traffic road forward road information, i.e. performs vehicle speed control based on the road curvature data, speed limit data, etc., about the through traffic road R1. The vehicle speed control is the same as at Step S13, and described in detail below.

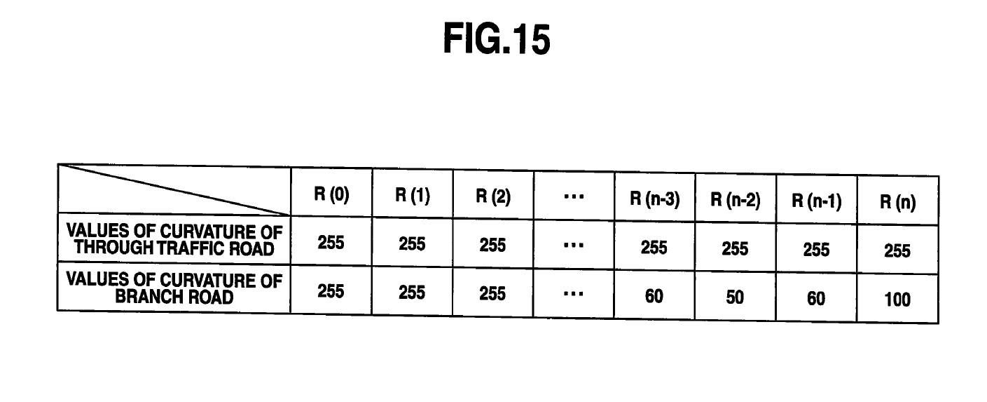

In each of Steps S13, S21, and S23, the road curvature data as part of forward road information is related to the distance between the respective point and the current location of host vehicle C1. For example, the road curvature data is sent to drive control device 2 in the format shown in FIG. 15. However, when the host vehicle C1 is outside the branch point control target section L3, the road curvature data is sent where each column for branch road R2 is set to an invalid value.

In this way, before host vehicle C1 enters the road selection estimation section L2 shown in FIG. 6, or before it is determined whether or not the host vehicle C1 is going to enter the branch road R2, the drive control device 2 shown in FIG. 5 has already acquired both of the through traffic road forward road information and branch road forward road information.

The procedure proceeds from Step S9, or Step S25 in FIG. 9, to Step S10 at which the vehicle operation support system determines whether or not the host vehicle C1 is traveling within the road selection estimation section L2. When determining at Step S10 that the host vehicle C1 is traveling within the road selection estimation section L2, then the procedure proceeds to Step S11 at which the vehicle operation support system estimates the lane in which the host vehicle C1 is traveling, i.e. estimates which one of through traffic road R1 and branch road R2 the host vehicle C1 is traveling in. In this estimation, deceleration lane R3, which is connected between the through traffic road R1 and branch road R2, may be regarded as part of branch road R2.

The estimation at Step S11 is performed with reference to the result of image recognition from image recognition device 3 by navigation system 1 and the road selection estimation part 13 of drive control device 2 in parallel.

When the host vehicle C1 has been traveling in the left one of two lanes of the through traffic road R1, the information that the branch road R2 branches to the left side from the through traffic road R1 is obtained with reference to the link type of the branch road R2, as described above.

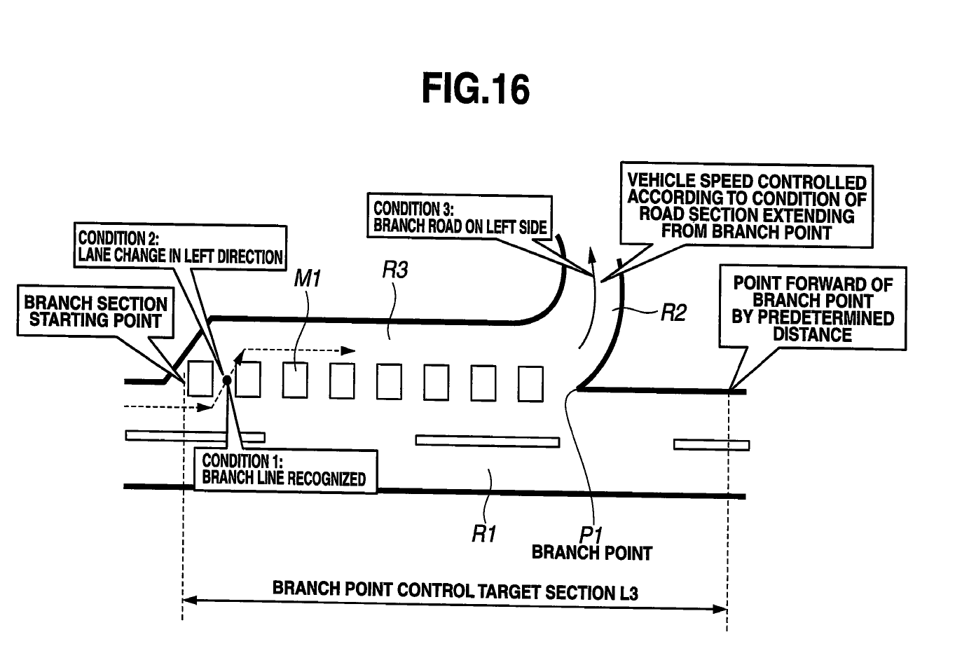

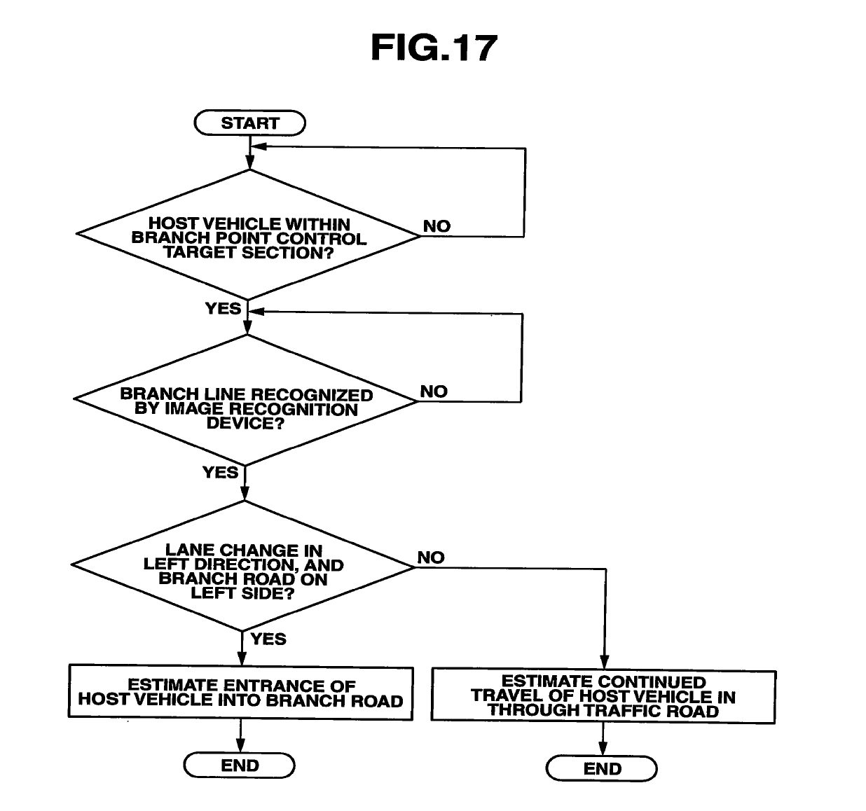

As shown in FIGS. 16 and 17, the expressway is provided with a branch line M1 in the form of a bold broken line, which is located as a center line at the boundary between the left lane of through traffic road R1 and deceleration lane R3 leading to branch road R2. Accordingly, when the image recognition device 3 recognizes the branch line M1 as a center line in the image provided by on-board camera 4, and the behavior of the host vehicle C1 indicates a lane change to the left side, namely, when it is determined that the host vehicle C1 is straddling the branch line M1, then the vehicle operation support system determines that the host vehicle C1 is entering the branch road R2. Here, entrance into deceleration lane R3 is regarded as entrance into branch road R2. In addition to the criterion described above, operation of a winker may be checked for road selection estimation or lane selection information. The lane marking line information and lane selection information are provided by image recognition device 3, whereas the branch direction information is provided by navigation system 1, as described above.

On the other hand, when determining that the host vehicle C1 is not performing lane change to the left side, then the vehicle operation support system determines that the host vehicle C1 is traveling on the through traffic road R1. The foregoing method shown in FIGS. 16 and 17 is referred to as “road selection estimation algorism 1” as in FIG. 5.

The foregoing method may fail, when image recognition device 3 fails to recognize that the host vehicle C1 is straddling the branch line M1. Accordingly, entrance into deceleration lane R3 leading to branch road R2 is also identified by the following method.

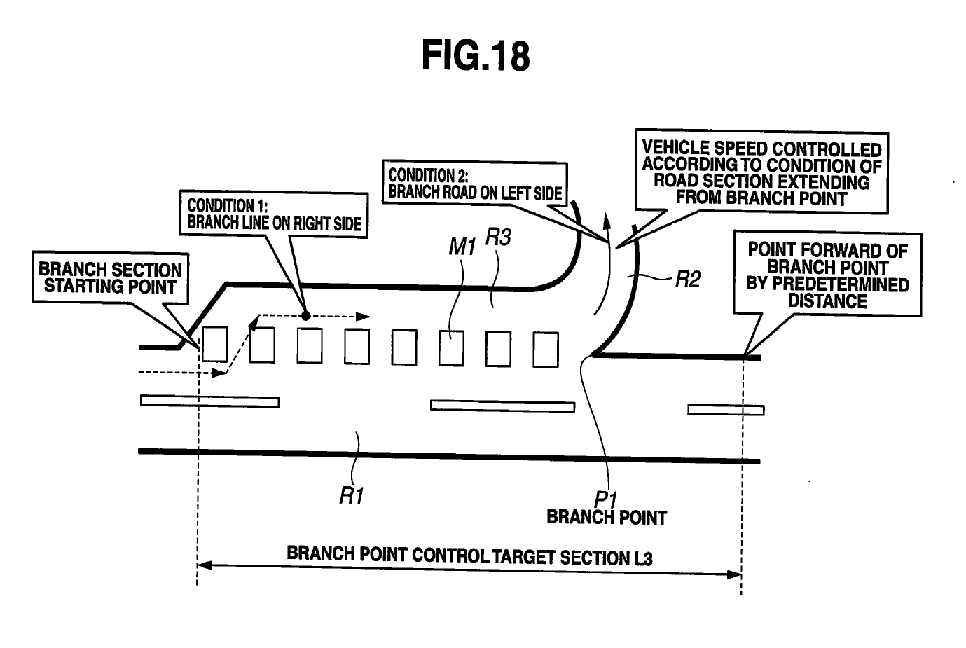

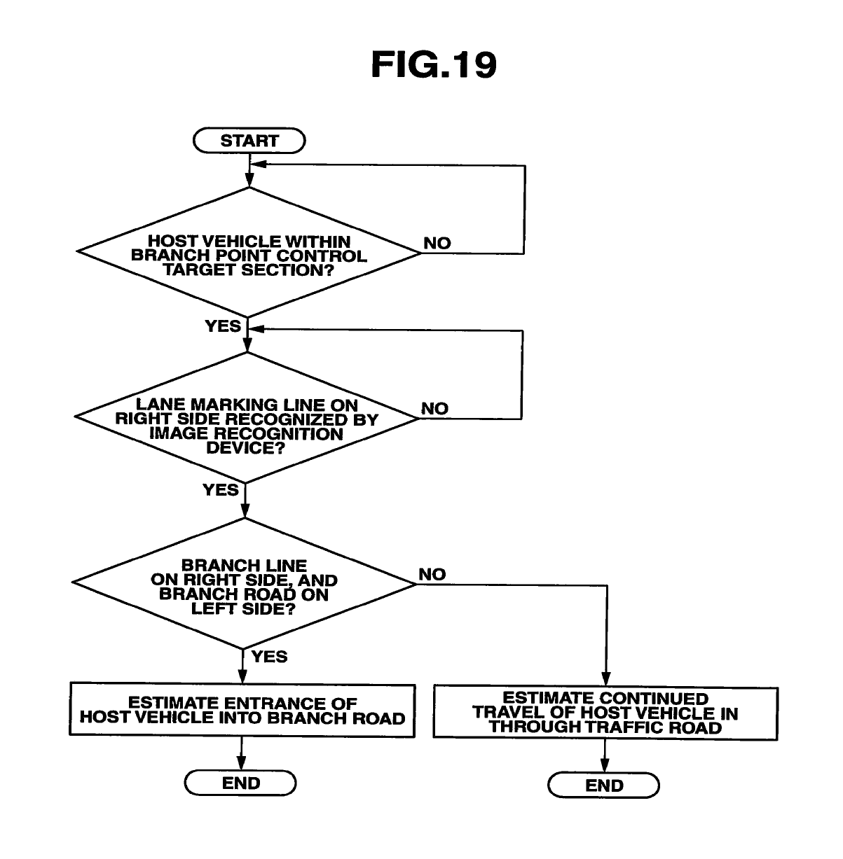

FIGS. 18 and 19 shows a situation where host vehicle C1 has been traveling in the left one of two lanes of the through traffic road R1. The information that the branch road R2 branches to the left side from the through traffic road R1 is obtained with reference to the link type of the branch road R2, as described above. When the host vehicle C1 has performed lane change from through traffic road R1 to deceleration lane R3 leading to branch road R2, and image recognition device 3 recognizes the branch line M1 on the right side of host vehicle C1 in the image, then the vehicle operation support system determines that the host vehicle C1 has entered the branch road R2. The foregoing method is referred to as “road selection estimation algorism 2” as in FIG. 5.

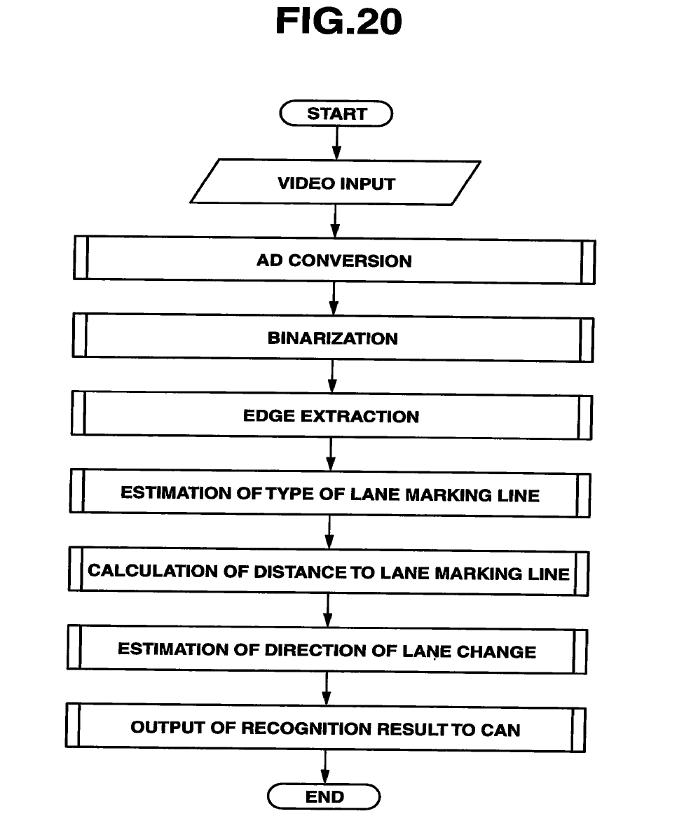

The operation of image recognition device 3 is implemented by a procedure shown in FIG. 20. Specifically, image recognition device 3: receives an image or video which is acquired by on-board camera 4; treats the image or video with AD conversion, binarization, and edge extraction; recognizes the type of each detected lane marking line, for example, by pattern matching, where branch line M1 is identified in the form of a bold broken line; calculates the distance to each detected lane marking line; calculates or estimates the direction of lane change of host vehicle C1; and outputs the result of recognition to the CAN network.

The road selection estimation is thus performed at Step S11 in the flow chart of FIG. 8. After the road selection estimation, navigation system 1 corrects the location of host vehicle C1 on the map by map matching operation with locator 7 with reference to the result of road selection estimation.

On the other hand, subsequent to Step S11, at Step S12, the forward road information selection part 14 of drive control device 2 selects one of the through traffic road forward road information and the branch road forward road information with reference to the result of road selection estimation outputted from road selection estimation part 13. In the situation shown in FIGS. 16 and 18 where it is determined that the host vehicle C1 has entered the branch road R2 (or deceleration lane R3 leading to branch road R2), the forward road information selection part 14 selects the branch road forward road information of the through traffic road forward road information and the branch road forward road information which are beforehand received by the forward road information receiving part 11.

On the other hand, when determining at Step S11 that the host vehicle C1 is still traveling on the through traffic road R1, then the vehicle operation support system selects the through traffic road forward road information at Step S12.

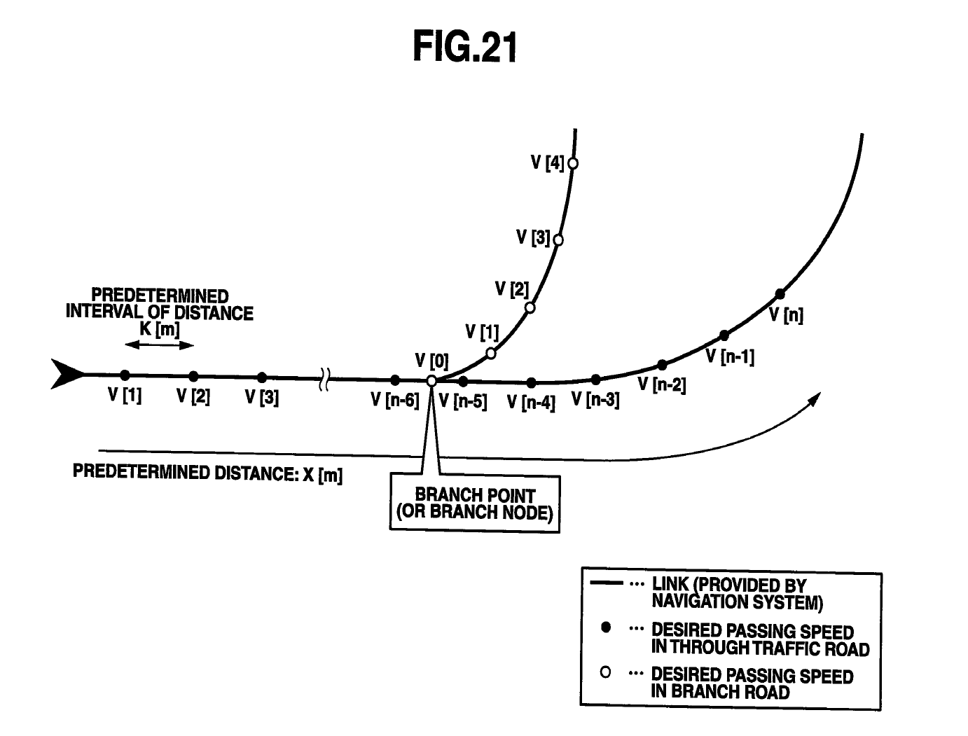

At Step S13, the desired travel speed calculation part 15 of drive control device 2 shown in FIG. 5 calculates desired passing speed V at each target point in branch road R2 forward of host vehicle C1 with reference to the selected branch road forward road information, for example, with reference to road curvature data and speed limit data about branch road R2, as shown in FIG. 21, and performs vehicle speed control with reference to the calculated desired passing speed V. For example, desired passing speed V is calculated with reference to road curvature data (radius of curvature R), using equation (1).

V=(R·G)^{1/2} (1)

where

V: desired passing speed,

R: radius of curvature, and

G: lateral acceleration.

Drive control device 2 performs the calculation at shorter intervals than navigation system 1 sends the information to drive control device 2. Accordingly, the distance to each target point is repeatedly corrected with reference to the distance of travel of host vehicle C1 during the interval between inputs of the information from navigation system 1.

After that calculation, the desired travel speed calculation part 15 of drive control device 2 implements vehicle speed control for host vehicle C1 in branch road R2 by: calculating desired engine torque and/or desired brake fluid pressure according to the calculated series of desired passing speed V; and sending command signals indicative of the desired engine torque and/or desired brake fluid pressure to an engine control unit and a brake control unit for controlling the engine throttle actuator and the brake actuator respectively. The desired travel speed calculation part 15 operates similarly also when the through traffic road forward road information is selected.

When it is determined that it is impossible to decelerate the host vehicle C1 to the desired passing speed, i.e. that the distance to each target point is too short to decelerate the host vehicle C1 to the respective desired passing speed, then the vehicle operation support system performs warning operation at Step S14. The warning operation is implemented by informing a driver with a warning signal such as a warning sound, for example.

More specifically, the operation of Step S14 is implemented as follows. A distance LL1 is defined as a distance required to decelerate the host vehicle C1 from a current travel speed V₀ to a desired passing speed V₁ at a longitudinal acceleration α. The distance LL1 is calculated using equation (2).

LL1=(V₁−V₀)/2α (2)

On the other hand, the distance between the current location of host vehicle C1 and the target point, LL2, is calculated. Then, the distance LL2 is compared with the distance LL1. When the distance LL1 is longer than the distance LL2, which means that the distance to the target point is too short to decelerate the host vehicle C1 to the respective desired passing speed, then the vehicle operation support system informs a driver by warning sound. The longitudinal acceleration a may be set to a predetermined value below a possible maximum value.

In case the host vehicle C1 is provided with an ACC (Adaptive Cruise Control) system, when the ACC system is turned off, the vehicle operation support system controls the travel speed of host vehicle C1 to the calculated desired passing speed. On the other hand, when the ACC system is turned on, and there is a vehicle preceding the host vehicle C1, then the vehicle operation support system performs vehicle speed control while setting the desired passing speed to the travel speed of the preceding vehicle. When the ACC system is turned on, and there is no vehicle preceding the host vehicle C1, then the vehicle operation support system performs vehicle speed control while maintaining the calculated desired passing speed.

In summary, in the vehicle operation support system according to the first embodiment, navigation system 1 provides drive control device 2 with both of the through traffic road forward road information and the branch road forward road information, i.e. with road information about the section of through traffic road R1 and branch road section R2 which are forward of branch section L1 shown in FIG. 6, before the host vehicle C1 reaches the branch section L1. This allows the drive control device 2 to calculate desired passing speed V in branch road R2 with reference to the forward road information which is already given at the moment the host vehicle C1 enters the branch section L1, and to perform vehicle speed control with reference to the calculated desired passing speed V, without awaiting forward road information which is to be given after a next operation of map matching of navigation system 1. This is effective for eliminating the delay in start of vehicle speed control which results from delay in map matching operation and communication, and especially effective for achieving an optimal, responsive, and real-time vehicle speed control when the host vehicle C1 enters the branch road R2 or deceleration lane R3 leading to branch road R2.

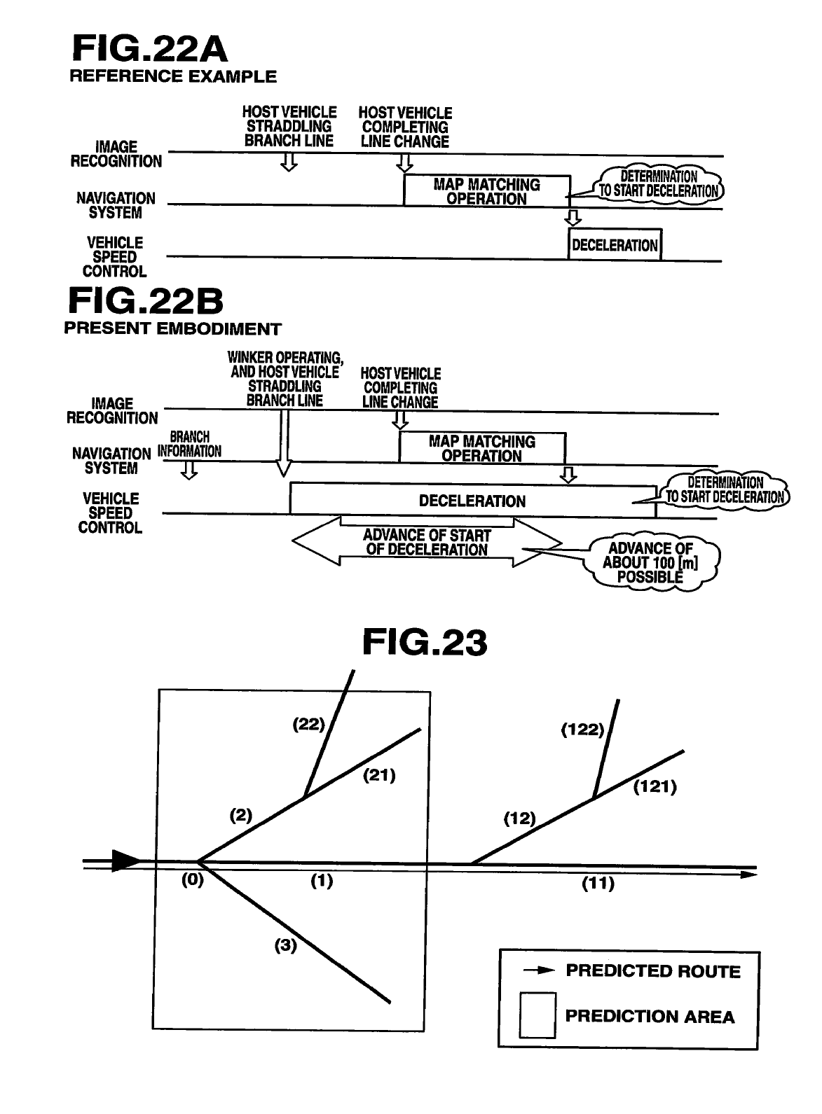

FIG. 22A is a time chart showing operation of vehicle operation support system according to a reference example, and FIG. 22B is a time chart showing operation of the vehicle operation support system shown in FIG. 1. In FIGS. 22A and 22B, “HOST VEHICLE STRADDLING BRANCH LINE” means a condition that the host vehicle C1 is straddling the branch line M1 shown in FIGS. 17 and 19 so that the host vehicle C1 is overlapping with branch line M1, and “HOST VEHICLE COMPLETING LANE CHANGE” means a condition that the host vehicle C1 completes lane change to deceleration lane R3 leading to branch road R2 so that the branch line M1 is recognized on the left side of host vehicle C1.

In the reference example shown in FIG. 22A, upon recognition of the condition “HOST VEHICLE COMPLETING LANE CHANGE”, a navigation system performs map matching operation, and then acquires forward road information, such as road curvature data, about a branch road section extending forward from a branch point. With reference to the forward road information, a drive control device calculates desired passing speed, and performs vehicle speed control to decelerate a host vehicle.

In contrast, in the vehicle operation support system according to the first embodiment, drive control device 2 is provided with both of the through traffic road forward road information and the branch road forward road information, i.e. with road information about the section of through traffic road R1 and branch road section R2 which are forward of branch point P1, before the host vehicle C1 reaches the preview information communication completion point P3 shown in FIG. 6. Upon recognition of the condition “HOST VEHICLE STRADDLING BRANCH LINE”, drive control device 2 immediately starts to calculate desired passing speed V with reference to the provided forward road information, and perform vehicle speed control to decelerate the host vehicle C1.

In this way, the vehicle operation support system according to the first embodiment can start vehicle speed control to decelerate the host vehicle C1, without awaiting completion of map matching operation which is to be performed upon recognition of the condition “HOST VEHICLE COMPLETING LANE CHANGE”. This allows to start the vehicle deceleration control at an early timing, or at an advanced point, as compared to the reference example, where advance of about 100 m is possible. The vehicle operation support system thus achieves a responsive real-time vehicle speed control.

In addition, as compared to the reference example where it is necessary to provide road information about a road section where vehicle speed control is to be performed, by acquiring and merging road information about the section between host vehicle C1 and branch point P1 to road information about branch road R2 after map matching operation, the vehicle operation support system according to the first embodiment is advantageous because both of the road information about the section of through traffic road R1 extending forward of host vehicle C1 and the road information about branch road R2 are already provided at preview information communication completion point P3.

The following describes detailed preview operation of the preview part 8 of navigation system 1. As described above, the preview part 8 is configured to access the locator 7 and map database 5 at intervals of the predetermined time period or predetermined constant time period, and acquire or collect map data and road data about the predetermined region around the host vehicle C1 and the predetermined region forward of host vehicle C1, from map database 5, with reference to the location of host vehicle C1 provided by locator 7.

During the preview operation, the preview part 8 assigns unique link numbers (referred to as link IDs) to links which branch from each branch point, so as to make it possible to deal with situations where a plurality of links branch from a branch point, and situations where a branch link branches into branch links, as shown in FIG. 23 where bracketed numbers represent link IDs. For example, link IDs are assigned as follows. As a link branches at a branch point (branch node) into branch links, a number having an incremented number of columns is assigned to the branch links. At each branch point, continuous link IDs are assigned to a plurality of branch links branching from the branch point, where the link ID is incremented in the counterclockwise direction.

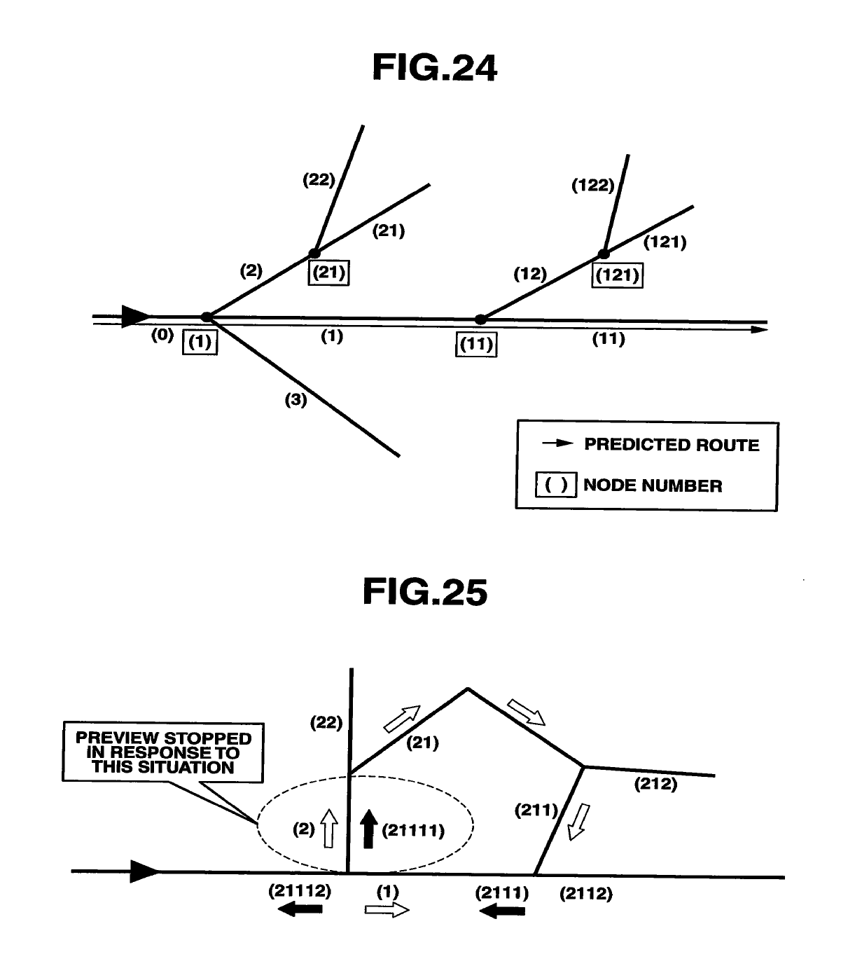

Similarly, during the preview operation, the preview part 8 assigns unique node numbers (referred to as node IDs) to branch nodes (or branch points), as shown in FIG. 24 where each bracketed number in a box represents a node ID. The node ID of each branch node is set to the smallest one of the link IDs of the links which branch from the branch node.

When recognizing during the preview operation that different link IDs are assigned to a link, and thereby recognizing that the predicted route includes a closed loop as shown in FIG. 25, then navigation system 1 stops the preview operation. This prevents the preview part 8 and route prediction part 9 from unnecessarily investigating a route which includes the same links and the same nodes as one of the investigated routes.

Although road curvature data is obtained as part of forward road information by reading from map database 5, or by the calculation described above in the first embodiment, the road curvature data may be obtained differently. For example, road curvature data may be obtained by extracting left and right lane marking lines in an image acquired by an additional front on-board camera, and calculating road curvature with reference to curvature of the lane marking lines.

### Second Embodiment

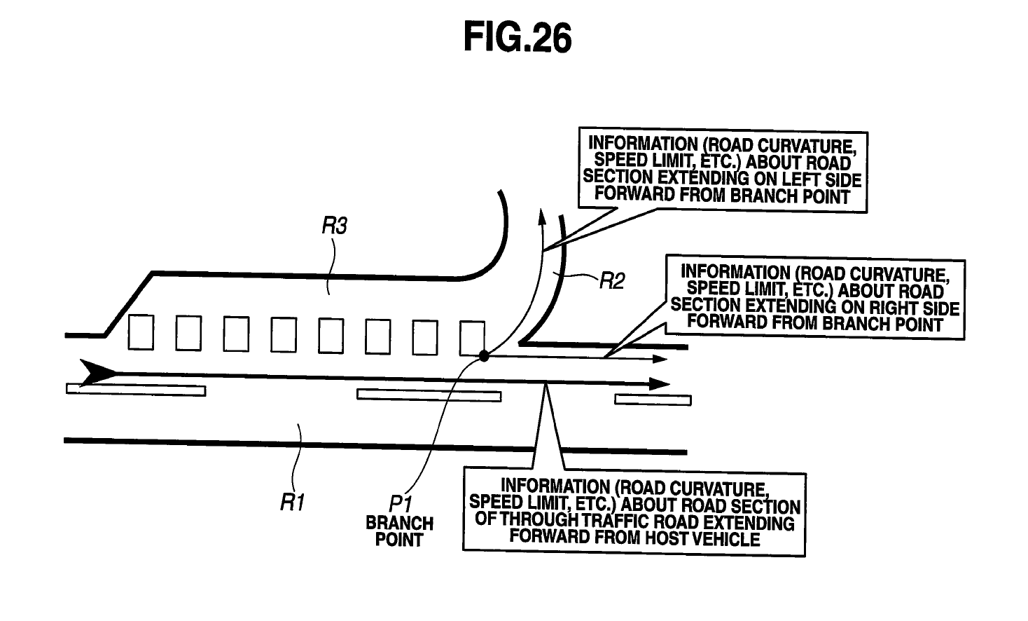

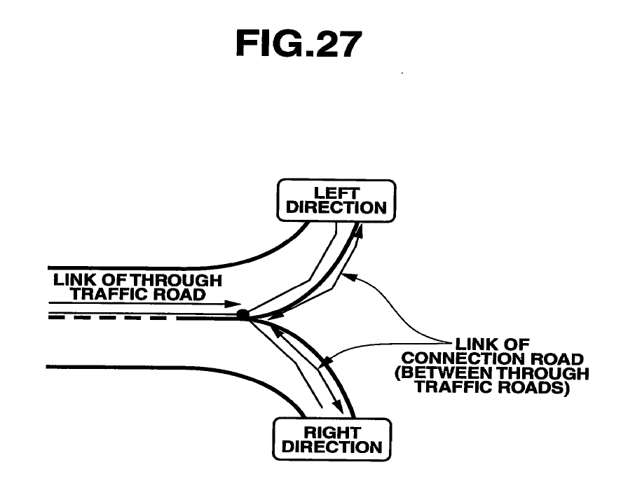

The following describes a vehicle operation support system according to a second embodiment of the present invention with reference to FIGS. 26 to 36. As described above, in the first embodiment, the information that the branch road R2 as well as deceleration lane R3 branches from through traffic road R1 at branch point P1, and that the branch road R2 branches to the left side, is obtained with reference to the link type of branch road R2 which is stored in map database 5. The vehicle operation support system according to the second embodiment is configured to deal with a branch section where branch road R2 is not discriminated from through traffic road R1 in map data, although as shown in FIG. 26, the branch section has substantially the same shape as the section shown in FIG. 11. Similar to the branch section shown in FIG. 26, at a junction section in an expressway as shown in FIG. 27 where a road branches into two branch roads, the link of each branch road is a connection road (between through traffic roads) link so that it is possible to recognize that a road branches into two branch roads, but the two branch roads are not discriminated from each other in map data. In the situation shown in FIG. 26, forward road information about the section of through traffic road R1 extending on the right side forward from branch point P1 is referred to as “right branch road forward road information”. Forward road information about branch road section R2 extending on the left side forward from branch point P1 is referred to as “left branch road forward road information”. Forward road information about the section of through traffic road R1 extending forward from host vehicle C1 is referred to as “through traffic road forward road information” or “overall through traffic road forward road information” if strictly described.

The vehicle operation support system according to the second embodiment has the same hardware configuration as shown in FIGS. 1, 3, and 5 in the first embodiment.

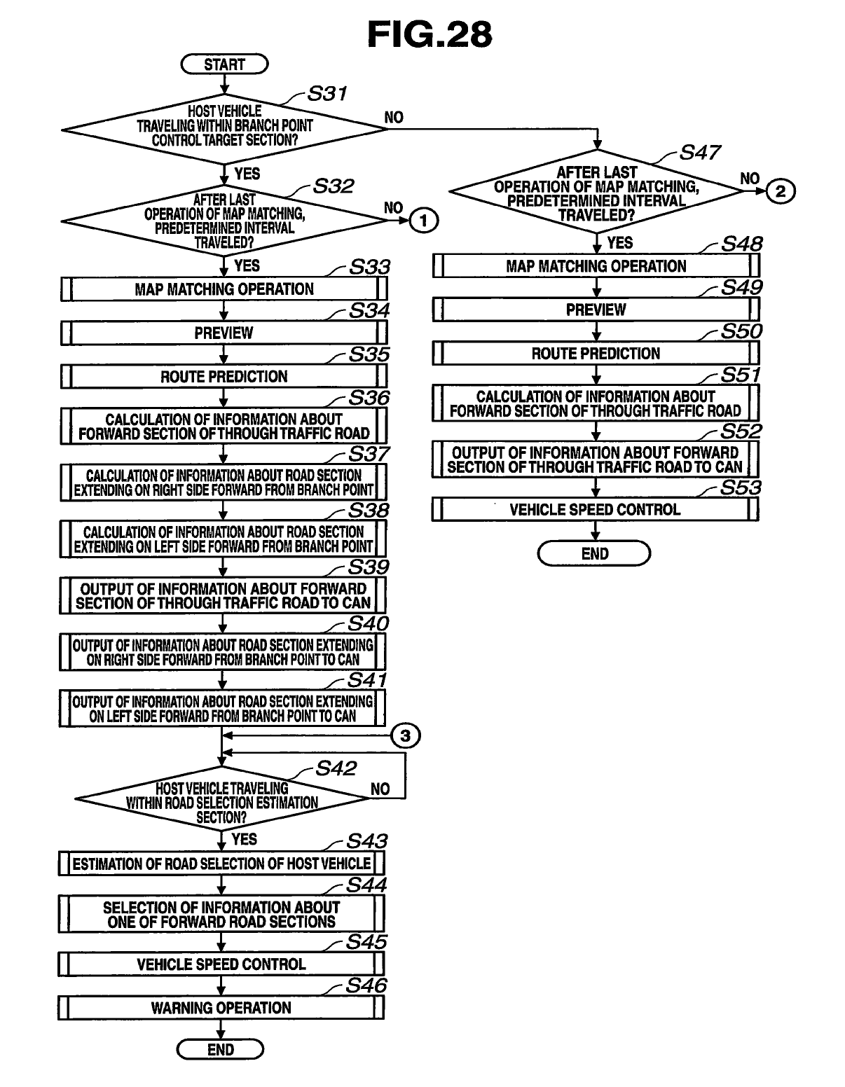

FIGS. 28 to 30 show a procedure of branch point control to be performed by the vehicle operation support system according to the second embodiment. Steps S31 to S35 in FIG. 28 are identical to Steps S1 to S5 in FIG. 8.

When determining that the host vehicle C1 is traveling within the branch point control target section L3 shown in FIG. 6, i.e. when determining that the host vehicle C1 has reached the preview starting point P4 shown in FIG. 6, then navigation system 1 acquires by collection or calculation at the predetermined intervals or predetermined constant intervals the through traffic road forward road information in the form of information (road type data, road curvature data, speed limit data, etc.) about a section of through traffic road R1 included in the predicted route, which section extends forward by a predetermined distance from host vehicle C1, at Step S36. Naturally, the information about the section of through traffic road R1 extending forward from host vehicle C1 includes the through traffic road forward road information which is information about the section of through traffic road R1 extending forward from branch point P1. Before host vehicle C1 reaches the preview information communication completion point P3 shown in FIG. 6, navigation system 1 sends or outputs the acquired overall through traffic road forward road information to drive control device 2 through the CAN network, at Step S39.

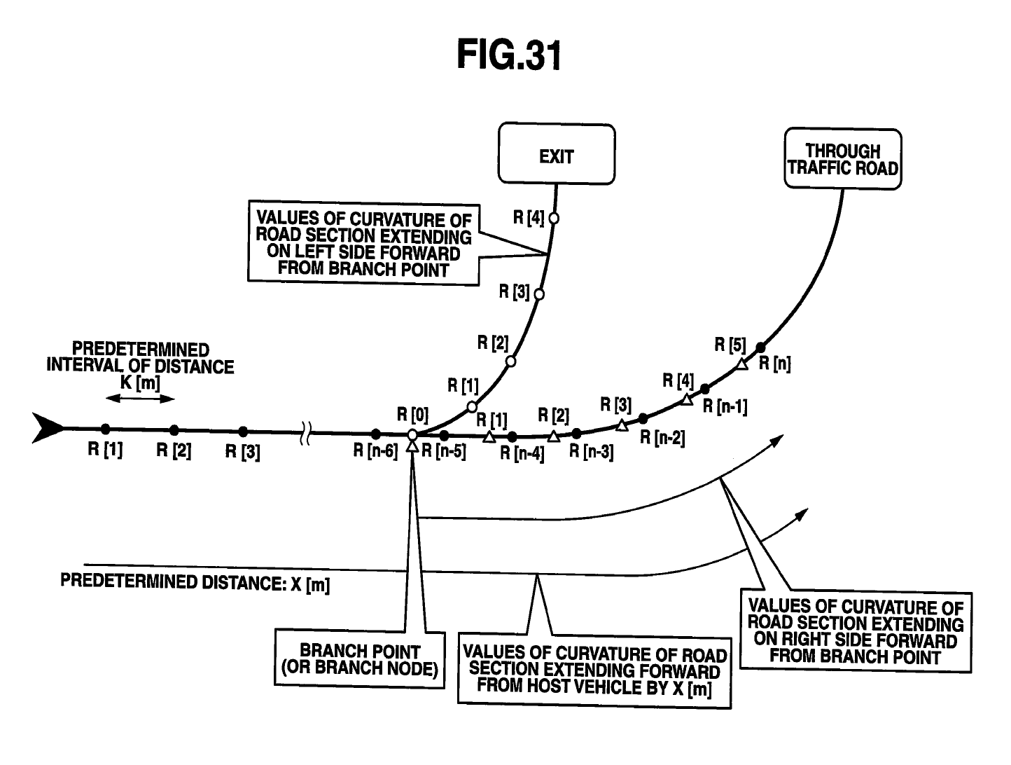

For example, navigation system 1 acquires road curvature data in the form of radius of horizontal curvature R[n] as an element of the overall through traffic road forward road information, as follows. As shown in FIG. 31, navigation system 1 acquires at the predetermined intervals or predetermined constant intervals the radius of curvature of through traffic road R1 at n points, R[i] (i=0, 1, 2, . . . , n, i=0 indicating the current location of host vehicle C1), where the points are arranged in the through traffic road R1 at intervals of a predetermined distance k (m) between the current location of host vehicle C1 and a point forward of the current location by a predetermined forward distance x (m). Then, navigation system 1 sends the acquired data to drive control device 2.

Similarly, navigation system 1 obtains by collection or calculation at the predetermined intervals or predetermined constant intervals the left branch road forward road information which is information (road type data, road curvature data, speed limit data, etc.) about a section of branch road R2 extending forward by a predetermined distance from branch point P1 which is within the predetermined area of prediction, at Step S38. Before host vehicle C1 reaches the preview information communication completion point P3 shown in FIG. 6, navigation system 1 sends or outputs the acquired left branch road forward road information to drive control device 2 through the CAN network, at Step S41.

Similarly, navigation system 1 obtains by collection or calculation at the predetermined intervals or predetermined constant intervals the right branch road forward road information which is information (road type data, road curvature data, speed limit data, etc.) about a section of through traffic road R1 extending forward by a predetermined distance from branch point P1 which is within the predetermined area of prediction, at Step S37. Before host vehicle C1 reaches the preview information communication completion point P3 shown in FIG. 6, navigation system 1 sends or outputs the acquired right branch road forward road information to drive control device 2 through the CAN network, at Step S40.

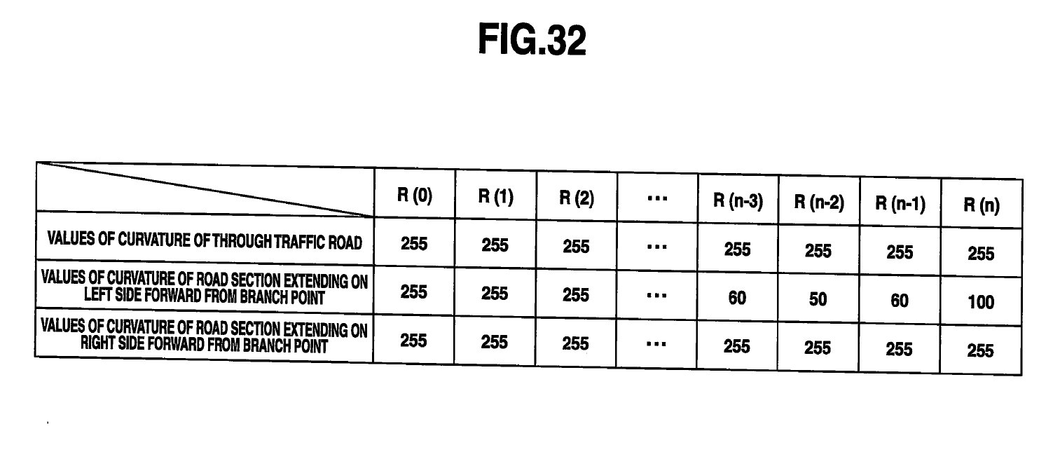

For example, navigation system 1 acquires road curvature data in the form of radius of horizontal curvature R[n] as an element of the left branch road forward road information or right branch road forward road information, as shown in FIG. 31, as in the first embodiment. For example, the road curvature data is sent to drive control device 2 in the format shown in FIG. 32. However, when the host vehicle C1 is outside the branch point control target section L3, the road curvature data is sent where each column for branch road R2 and the section of through traffic road R1 forward of branch point P1 is set to an invalid value.

When determining at Step S31 that the host vehicle C1 is traveling outside of the branch point control target section L3 shown in FIG. 6, then the procedure proceeds to Step S47. Steps S47 to S55 in FIGS. 28 and 30 are identical to Steps S15 to S23 in FIG. 8.

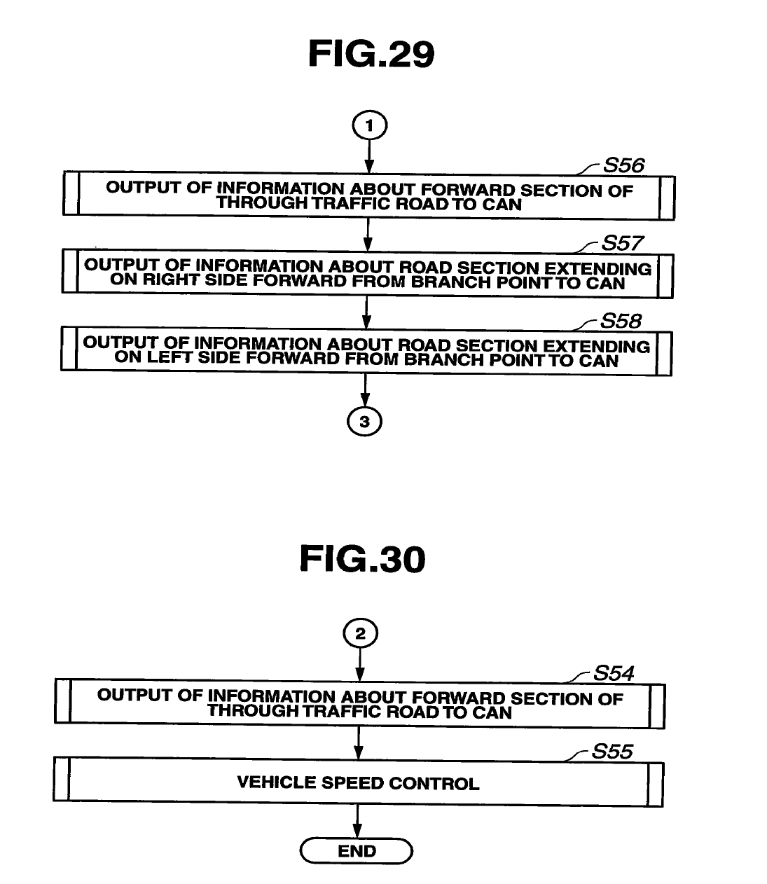

Steps S56 to S58 in FIG. 29 are similar to Steps S24 and S25 in FIG. 9. Namely, when determining at Step S32 that the host vehicle C1 has not yet traveled the predetermined interval after the last operation of map matching, the navigation system 1 sends or outputs the previously-acquired overall through traffic road forward road information, and left branch road forward road information, and right branch road forward road information to drive control device 2 through the CAN network, at Steps S56 to S58 in FIG. 29.

The procedure proceeds from Step S41, or Step S58 in FIG. 29, to Step S42 at which the vehicle operation support system determines whether or not the host vehicle C1 is traveling within the road selection estimation section L2. When determining at Step S42 that the host vehicle C1 is traveling within the road selection estimation section L2, then the procedure proceeds to Step S43 at which the vehicle operation support system estimates the lane in which the host vehicle C1 is traveling, i.e. estimates which one of through traffic road R1 and branch road R2 the host vehicle C1 is traveling in. In this estimation, deceleration lane R3, which is connected between the through traffic road R1 and branch road R2, may be regarded as part of branch road R2.

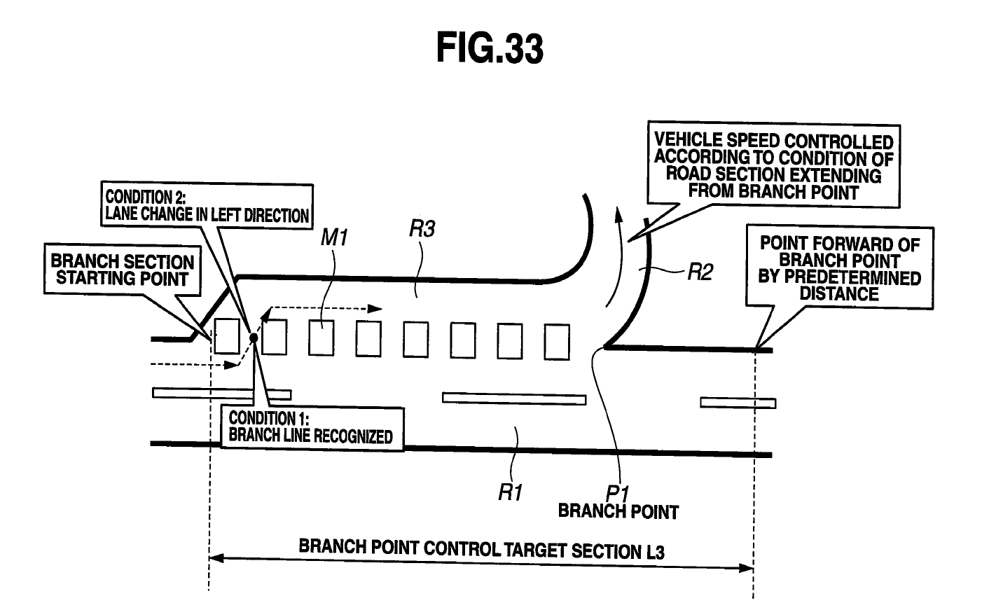

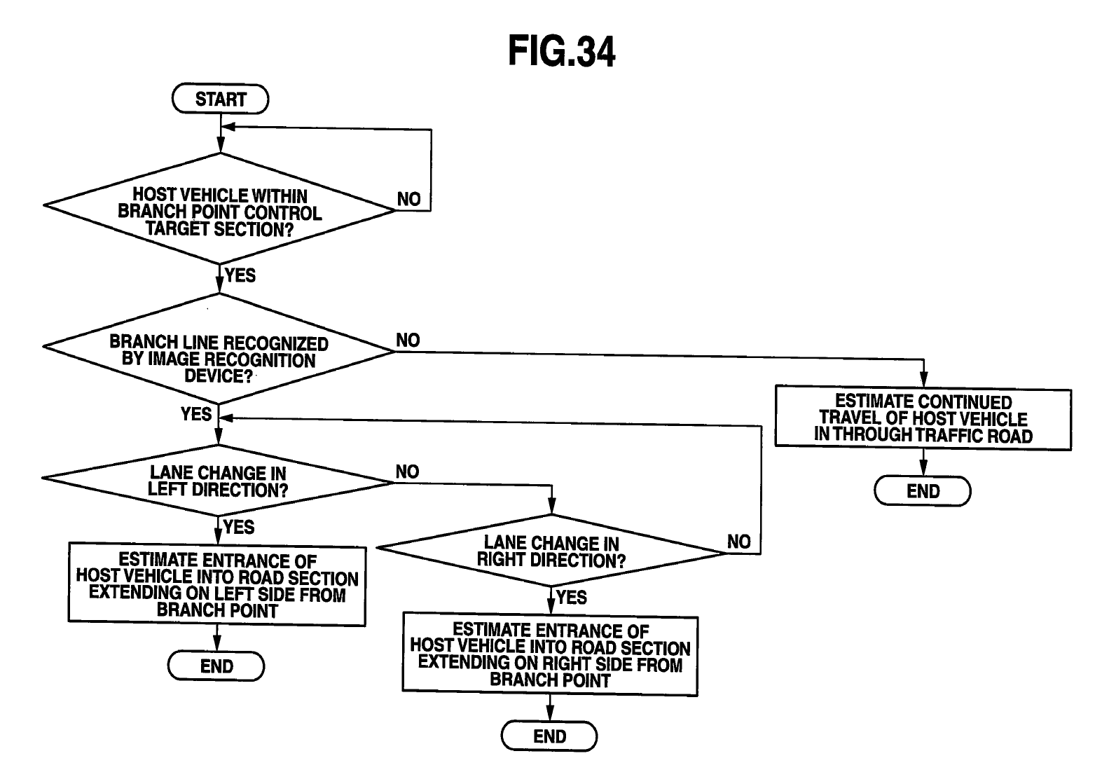

The estimation of Step S43 is similar to the estimation of Step S11 in FIG. 8. Specifically, as shown in FIGS. 33 and 34, when recognizing or estimating that the host vehicle C1 is straddling a branch line M1 in the form of a bold broken line, and performing lane change to the left side, then the image recognition device 3 determines that the host vehicle C1 is entering a left branch road section which extends on the left side forward from branch point P1. On the other hand, when recognizing or estimating that the host vehicle C1 is straddling the branch line M1, and performing lane change to the right side, then the image recognition device 3 determines that the host vehicle C1 is entering a right branch road section which extends on the right side forward from branch point P1. When recognizing or estimating that the host vehicle C1 is not straddling the branch line M1, then the image recognition device 3 determines that the host vehicle C1 is traveling on through traffic road R1.

The foregoing method may fail, when image recognition device 3 fails to recognize that the host vehicle C1 is straddling the branch line M1. Accordingly, entrance into one of left and right branch road sections extending forward from branch point P1 is also identified by the following method.

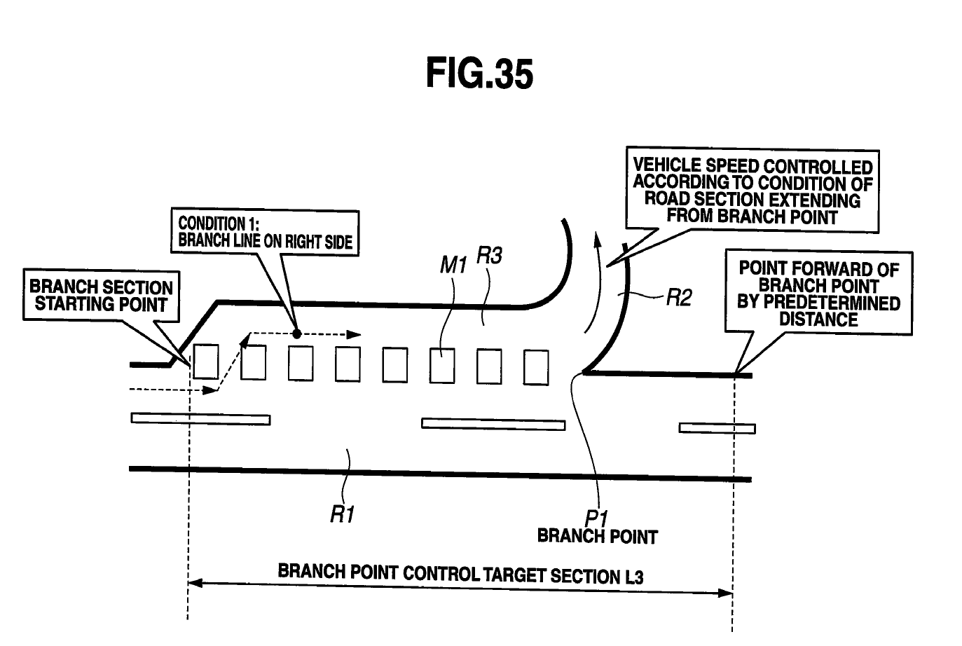

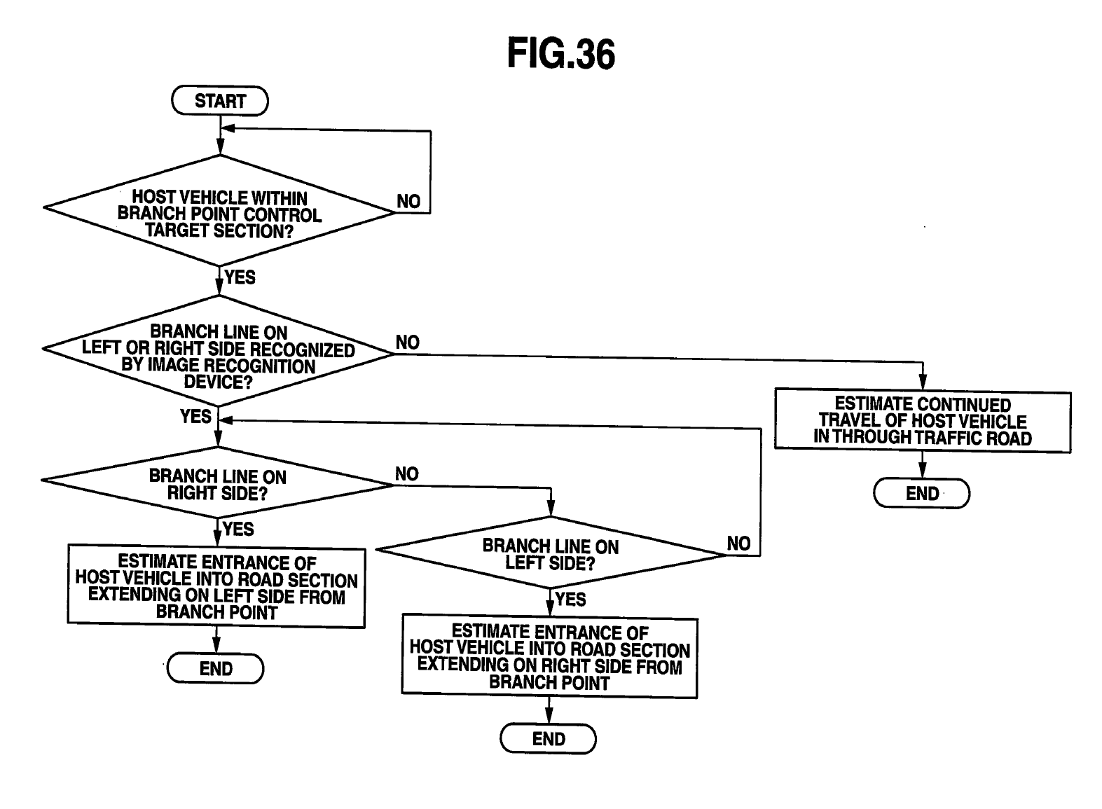

FIGS. 35 and 36 show a situation where the host vehicle C1 has been traveling in the left one of two lanes of the through traffic road R1, and then performs lane change to the left side or right side. In this situation, when image recognition device 3 recognizes the branch line M1 in the form of a bold broken line on the left side or right side of host vehicle C1 in the image, and recognizes that the branch line M1 is on the right side of host vehicle C1, then the vehicle operation support system determines that the host vehicle C1 has entered the left branch road section extending forward from branch point P1. On the other hand, when image recognition device 3 recognizes that the branch line M1 is on the left side of host vehicle C1, then the vehicle operation support system determines that the host vehicle C1 has entered the right branch road section extending forward from branch point P1.

Subsequent to Step S43, Steps S44 to S46 in FIG. 28 are similar to Step S12 to S14 in FIG. 8. Specifically, the forward road information selection part 14 of drive control device 2 selects one of the left branch road forward road information and right branch road forward road information with reference to the result of road selection estimation outputted from road selection estimation part 13. Then, drive control device 2 performs vehicle speed control with reference to the desired passing speed V which is calculated by desired travel speed calculation part 15 with reference to the selected forward road information.

In this way, the vehicle operation support system according to the second embodiment is capable of suitably performing vehicle speed control in a road section extending forward from a branch point, even when a through traffic road and a branch road are not discriminated from each other at the branch point in map data.

### Third Embodiment

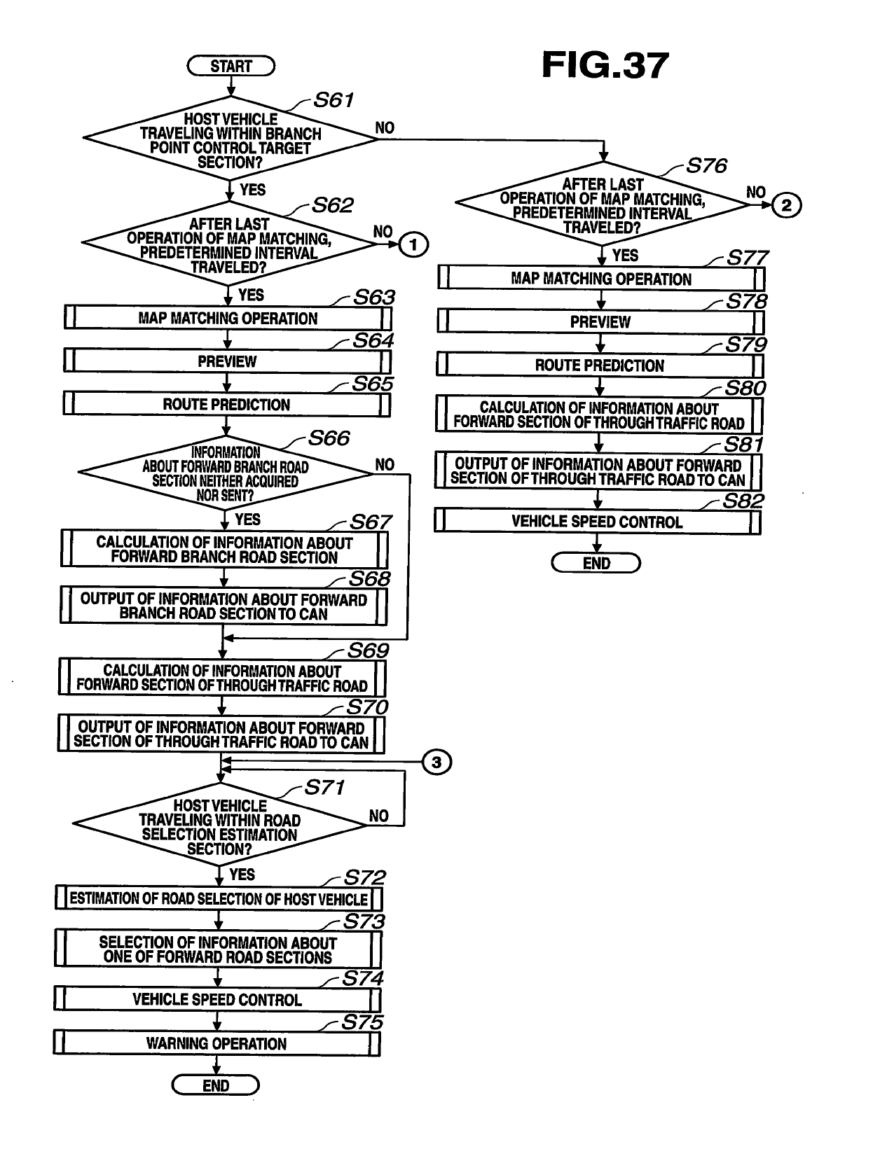

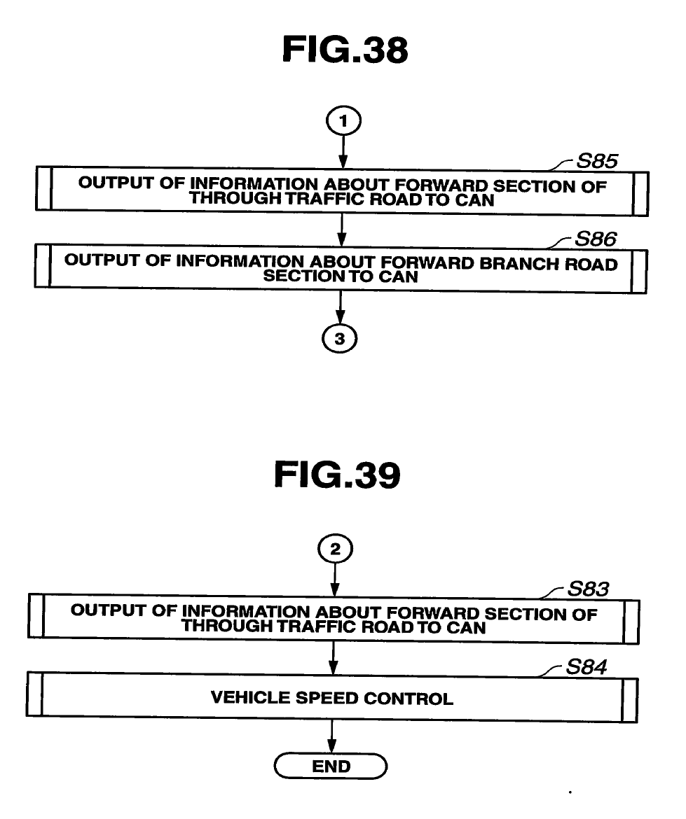

The following describes a vehicle operation support system according to a third embodiment of the present invention with reference to FIGS. 37 to 39. FIGS. 37 to 39 show a procedure of branch point control to be performed by the vehicle operation support system according to the third embodiment. The third embodiment differs from the first embodiment in provision of Steps S66 to S70 shown in FIG. 37 instead of Step S6 to S9 shown in FIG. 8.

The following describes Steps S66 to S70 in FIG. 37. At Step S66, the vehicle operation support system determines whether the branch road forward road information is neither acquired nor sent. When the answer to Step S66 is affirmative (YES), then the procedure proceeds to Step S67 at which in response to recognition that the host vehicle C1 has reached the preview starting point P4, navigation system 1 obtains by collection or calculation the branch road forward road information which is information about a section of branch road R2 extending forward by a predetermined distance from branch point P1 which is within the predetermined area of prediction, at Step S67. The branch road forward road information includes road type data, road curvature data, speed limit data, etc., as in the first embodiment. Before host vehicle C1 reaches the preview information communication completion point P3 shown in FIG. 6, navigation system 1 sends or outputs the acquired branch road forward road information to drive control device 2 through the CAN network, at Step S68.

According to Steps S66 to S68, the branch road forward road information is acquired only once, and sent to drive control device 2 through the CAN network intermittently on a plurality of occasions while the host vehicle C1 is traveling within the branch point control target section L3 shown in FIG. 6. The branch road forward road information is maintained unchanged or not updated, while the host vehicle C1 is traveling within the branch point control target section L3.

Subsequent to Step S68 or S66, in response to recognition that the host vehicle C1 has reached the preview starting point P4 shown in FIG. 6, then navigation system 1 acquires by collection or calculation at the predetermined intervals or predetermined constant intervals the through traffic road forward road information in the form of information (road type data, road curvature data, speed limit data, etc.) about a section of through traffic road R1 extending forward by a predetermined distance from host vehicle C1, at Step S69. Naturally, the information about the section of through traffic road R1 extending forward from host vehicle C1 includes the through traffic road forward road information which is information about the section of through traffic road R1 extending forward from branch point P1, and is referred to as “overall through traffic road forward road information” if strictly described. Before host vehicle C1 reaches the preview information communication completion point P3 shown in FIG. 6, navigation system 1 sends or outputs the acquired overall through traffic road forward road information to drive control device 2 through the CAN network, at Step S70.

Once the answer to Step S66 becomes negative (NO), only the through traffic road forward road information is acquired and sent at the predetermined intervals or predetermined constant intervals at Steps S69 and S70. Accordingly, in contrast to the branch road forward road information, the through traffic road forward road information is repeatedly updated at the predetermined intervals or predetermined constant intervals.

Steps other than Steps S66 to S70 in FIGS. 37, 38 and 39 are identical to corresponding steps in FIGS. 8, 9 and 10 for the first embodiment.

The vehicle operation support system according to the third embodiment produces similar advantageous effects as in the first embodiment. In addition, the feature according to the third embodiment that the branch road forward road information is acquired and sent only once, is effective for reducing the load of acquiring the branch road forward road information. The feature is significantly effective for reducing the load, especially when road curvature data as part of branch road forward road information is obtained by calculation.

### Fourth Embodiment

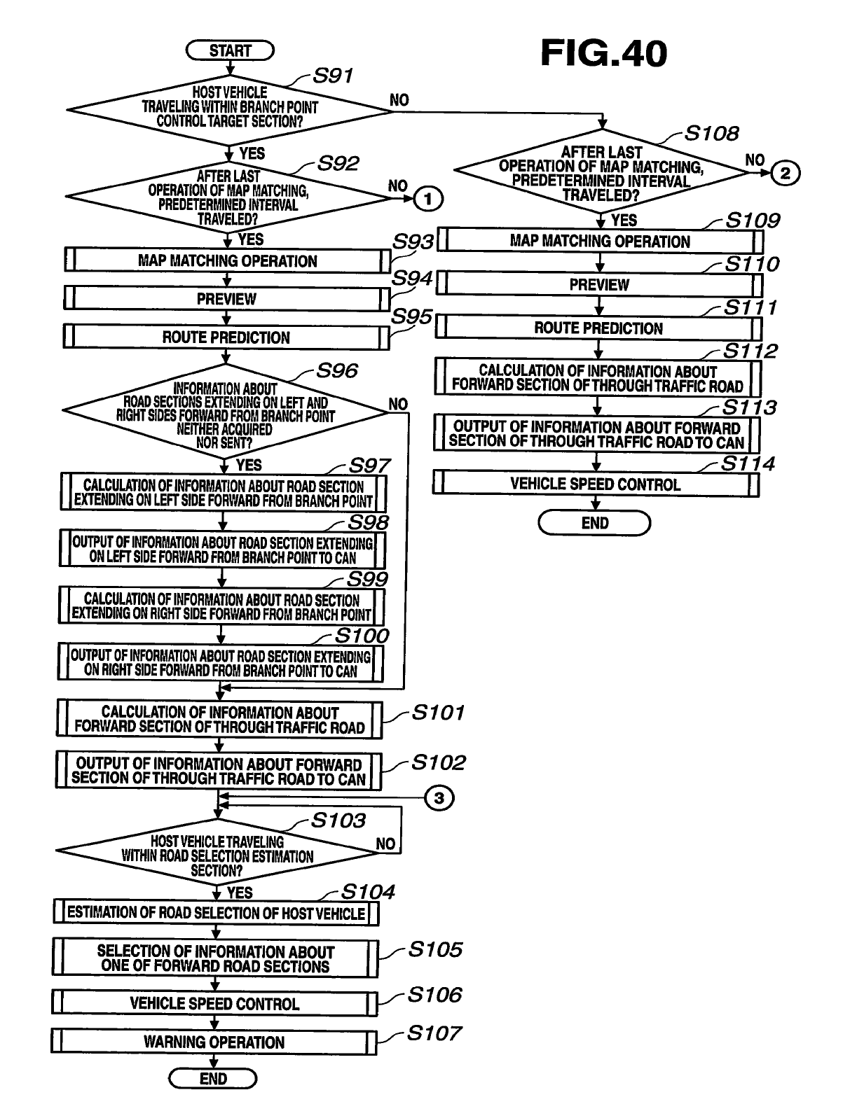

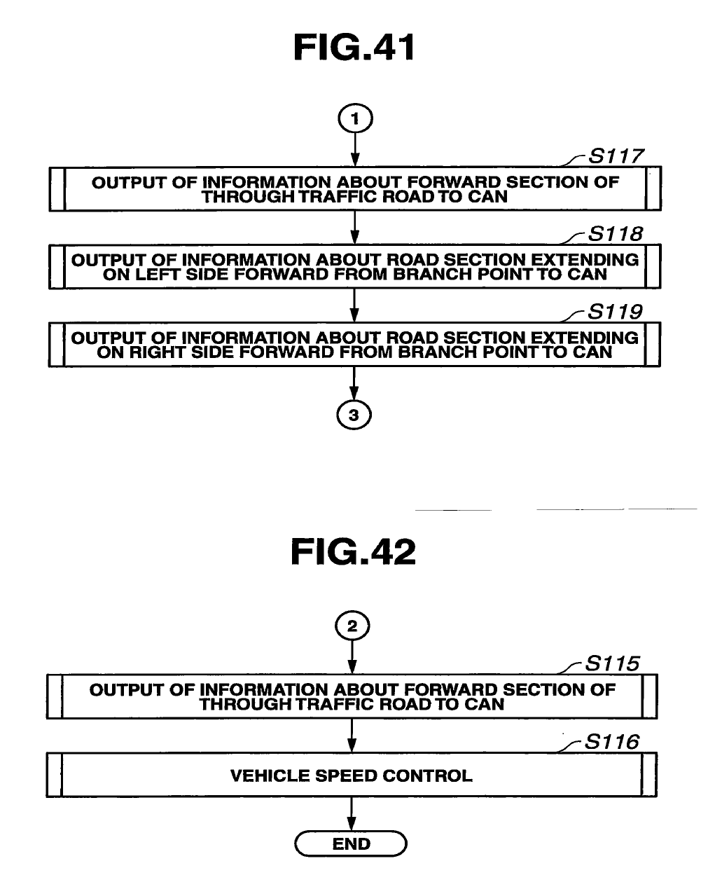

The following describes a vehicle operation support system according to a fourth embodiment of the present invention with reference to FIGS. 40 to 42. FIGS. 40 to 42 show a procedure of branch point control to be performed by the vehicle operation support system according to the fourth embodiment. The fourth embodiment is created by modifying the second embodiment with the concept of the third embodiment. Accordingly, the fourth embodiment differs from the second embodiment in provision of Steps S96 to S102 shown in FIG. 40 instead of Step S36 to S41 shown in FIG. 28.

The following describes Steps S96 to S102 in FIG. 40. At Step S96, the vehicle operation support system determines whether information about road sections extending on the left and right sides forward from branch point P1 is neither acquired nor sent. When the answer to Step S96 is affirmative (YES), then the procedure proceeds to Step S97 at which in response to recognition that the host vehicle C1 has reached the preview starting point P4, navigation system 1 obtains by collection or calculation the left branch road forward road information which is information (road type data, road curvature data, speed limit data, etc.) about a section of branch road R2 extending on the left side forward by a predetermined distance from branch point P1 which is within the predetermined area of prediction. Before host vehicle C1 reaches the preview information communication completion point P3 shown in FIG. 6, navigation system 1 sends or outputs the acquired left branch road forward road information to drive control device 2 through the CAN network, at Step S98.

According to Steps S96 to S98, the left branch road forward road information is acquired only once, and sent to drive control device 2 through the CAN network intermittently on a plurality of occasions while the host vehicle C1 is traveling within the branch point control target section L3 shown in FIG. 6. The left branch road forward road information is maintained unchanged or not updated, while the host vehicle C1 is traveling within the branch point control target section L3.

Similarly, at Step S99, in response to recognition that the host vehicle C1 has reached the preview starting point P4, navigation system 1 obtains by collection or calculation the right branch road forward road information which is information (road type data, road curvature data, speed limit data, etc.) about a section of through traffic road R1 extending on the right side forward by a predetermined distance from branch point P1 which is within the predetermined area of prediction. Before host vehicle C1 reaches the preview information communication completion point P3 shown in FIG. 6, navigation system 1 sends or outputs the acquired right branch road forward road information to drive control device 2 through the CAN network, at Step S100.

According to Steps S96, S99 and S100, the right branch road forward road information is acquired only once, and sent to drive control device 2 through the CAN network intermittently on a plurality of occasions while the host vehicle C1 is traveling within the branch point control target section L3 shown in FIG. 6. The right branch road forward road information is maintained unchanged or not updated, while the host vehicle C1 is traveling within the branch point control target section L3.

Subsequent to Step S100 or S96, in response to recognition that the host vehicle C1 has reached the preview starting point P4 shown in FIG. 6, then navigation system 1 acquires by collection or calculation at the predetermined intervals or predetermined constant intervals the through traffic road forward road information in the form of information (road type data, road curvature data, speed limit data, etc.) about a section of through traffic road R1 included in the predicted route, which section extends forward by a predetermined distance from host vehicle C1, at Step S101. Before host vehicle C1 reaches the preview information communication completion point P3 shown in FIG. 6, navigation system 1 sends or outputs the acquired through traffic road forward road information to drive control device 2 through the CAN network, at Step S102.

Once the answer to Step S96 becomes negative (NO), only the through traffic road forward road information is acquired and sent at the predetermined intervals or predetermined constant intervals at Steps S101 and S102. Accordingly, in contrast to the left branch road forward road information and right branch road forward road information, the through traffic road forward road information is repeatedly updated at the predetermined intervals or predetermined constant intervals.

Steps other than Steps S96 to S102 in FIGS. 40, 41 and 42 are identical to corresponding steps in FIGS. 28, 29 and 30 for the first embodiment.

The vehicle operation support system according to the fourth embodiment produces similar advantageous effects as in the second embodiment. In addition, the feature according to the fourth embodiment that the left and right branch road forward road information is acquired and sent only once, is effective for reducing the load of acquiring the left and right branch road forward road information. The feature is significantly effective for reducing the load, especially when road curvature data as part of left and right branch road forward road information is obtained by calculation.

The entire contents of Japanese Patent Application 2008-325081 filed Dec. 22, 2008 are incorporated herein by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A vehicle operation support system for a vehicle, comprising:
a navigation device; and
a drive control device configured to control with an actuator a driving state of the vehicle,
wherein:
the navigation device includes:
a map data storage part configured to store road information, wherein the road information includes branch point information; and
a road information acquiring part configured to:
acquire road curvature information with reference to the road information, wherein the road curvature information includes at least:
information about curvature of a first road section extending forward from a branch point; and
information about curvature of a second road section extending forward from the branch point; and
provide the drive control device with the road curvature information, before the vehicle reaches the branch point;
the drive control device includes a road selection estimation part configured to estimate entrance of the vehicle into one of the first and second road sections as a selected road section; and
the drive control device is further configured to control the driving state of the vehicle by operating the actuator with reference to the information about curvature of the selected road section, in response to estimation of entrance of the vehicle into the selected road section.

2. The vehicle operation support system as claimed in claim 1, wherein:
the actuator includes an automatic brake control device configured to automatically apply a braking force to the vehicle; and
the braking force is set with reference to the information about curvature of the selected road section for deceleration of the vehicle.

3. The vehicle operation support system as claimed in claim 2, wherein:
the branch point is a branch point in an expressway;
the first road section is a section of a through traffic road of the expressway; and
the second road section is an exit road section branching from the through traffic road at the branch point.

4. The vehicle operation support system as claimed in claim 3, wherein:
a branch point control target section is defined as extending backward from the branch point by a sum of:
a first distance that is traveled by the vehicle during a time interval between two consecutive operations of map matching performed by the navigation device;
a second distance that is traveled by the vehicle during a time period required for startup of the navigation device; and
a third distance that is required for deceleration of the vehicle at a predetermined deceleration from current travel speed to desired travel speed in the exit road section; and
the road information acquiring part is configured to acquire the road curvature information, in response to recognition that the vehicle reaches a preview starting point as a starting point of the branch point control target section.

5. The vehicle operation support system as claimed in claim 4, wherein:
a preview information communication completion point is defined as a point backward from the branch point by a sum of the second distance and the third distance; and
the road information acquiring part is configured to provide the drive control device with the road curvature information, before the vehicle reaches the preview information communication completion point.

6. The vehicle operation support system as claimed in claim 5, wherein the road information acquiring part is configured to:
acquire and provide the drive control device with information about curvature of a forward section of the through traffic road forward of the vehicle at intervals of a predetermined constant time period, in response to recognition that the vehicle is traveling outside the branch point control target section; and
provide the drive control device with the information about curvature of the forward section of the through traffic road and the information about curvature of the exit road section, in response to recognition that the vehicle is traveling within the branch point control target section, before the vehicle reaches the preview information communication completion point.

7. The vehicle operation support system as claimed in claim 2, wherein:
the braking force of the automatic brake control device is set with reference to desired passing speed depending on the information about curvature of the selected road section; and
the drive control device is configured to output a warning signal, in response to determination that it is impossible to decelerate the vehicle to the desired passing speed.
